(19) United States
(12) Patent Application Publication
(10) Pub. No.: US 2026/0273849 A1
(43) Pub. Date: Sep. 17, 2026

(54) AN ADDITIVE MANUFACTURING APPARATUS

(71) Applicant: AXTRA3D Inc.

(72) Inventor: Gianni Zitelli, Vicenza (IT)

(73) Assignee: AXTRA3D Inc., Dover (DE)

(21) Appl. No.: 19/168,794

(22) PCT Filed: Apr. 6, 2023
(86) PCT No.: PCT/EP2023/059100

§ 371 Date: Sep. 24, 2025

(51) Int. Cl. B29C 64/277; B29C 64/129; B29C 64/153; B29C 64/393; B33Y 30/00; B33Y 50/02

(52) U.S. Cl. CPC B29C 64/277; B29C 64/129; B29C 64/153; B29C 64/393; B33Y 30/00; B33Y 50/02

(57) ABSTRACT

An additive manufacturing apparatus (15) for additively manufacturing a three-dimensional object by solidifying a build material by electromagnetic radiation at a specific wavelength, particularly by photocuring a photocurable resin (5.1) which can be cured at a specific wavelength range, the apparatus (15) comprising: ⋅ - a container device (5), the container device delimiting a receiving volume for receiving a build material (5.1) which can be solidified by electromagnetic radiation at a specific wavelength, particularly photocurable resin which can be cured at a specific wavelength range, ⋅ - at least one first radiation device (8), and ⋅ - at least one second radiation device (9).

The invention relates to an additive manufacturing apparatus for additively manufacturing a three-dimensional object by solidifying a build material via electromagnetic radiation at a specific wavelength, particularly by photocuring a photocurable resin which can be cured at a specific wavelength.

Respective additive manufacturing apparatuses for additively manufacturing a three-dimensional object by solidifying a build material via electromagnetic radiation at a specific wavelength are generally known from the prior art and enable additively manufacturing a three-dimensional object by solidifying a solidifiable build material by successively selectively irradiating same with irradiation of a specific wavelength which results in that irradiated areas of the build material solidify to form a cross-section of the three-dimensional object to be built.

Respective apparatuses can be embodied as selective laser sintering, SLS, apparatuses configured to successively, particularly layerwise, irradiate a powdery build material, e.g. a powdery polymer material, with electromagnetic radiation, e.g. a directed light beam, at a specific wavelength which results in that respective areas of the build material melt and, upon subsequent cooling, solidify to form a form a cross-section of the three-dimensional object to be built. Further, respective apparatuses can be embodied as photocuring apparatuses configured to successively, particularly layerwise, irradiate a liquid photocurable build material, e.g. a photocurable resin, with electromagnetic radiation, e.g. a directed light beam and/or projected light images, at a specific wavelength which results in that respective areas of the build material cure and solidify to form a form a cross-section of the three-dimensional object to be built.

It is known that respective apparatuses can comprise a first radiation device, such as a DLP device, configured to generate and emit light images towards a build area and a second radiation device, such as a laser device, configured to emit directed light beams towards the built area. Notably, only the light sources of respective second radiation devices are configured to generate polarized light, whereas the light sources of respective first radiation devices are not configured to generate polarized light. As such, respective first radiation devices typically, require a separate polarizing element which converts the unpolarized light generated by the light source of the first radiation device into polarized light.

Having two radiation devices generating both one or more polarized light images and one or more directed polarized light beams allows providing superordinate coaxial radiation units which are configured to output one or more polarized light images having a specific wavelength and a first polarization and simultaneously output one or more directed polarized light beams also having the specific wavelength but a second polarization differing from the first polarization in its angular orientation towards the container device and build material disposed therein, respectively.

Respective coaxial radiation units typically, comprise a polarization coupling optic or a polarizing beam combiner, respectively configured to superpose the one or more polarized light images generated by the first radiation device and the one or more directed polarized light beams generated by the second radiation device which superposing requires a specific polarization of the one or more polarized light images and the one or more directed polarized light beams.

A drawback of these coaxial radiation units is that the configuration of the respective first radiation devices requires separate polarizing devices since the light sources of the first radiation devices cannot generate polarized light which is required for processing the one or more polarized light images via a respective polarization coupling optic or a polarizing beam combiner, respectively.

It is therefore, an object of the present invention to provide an improved apparatus for additively manufacturing a three-dimensional object by solidifying a build material via electromagnetic radiation at a specific wavelength, particularly by photocuring a photocurable resin which can be cured at a specific wavelength, which obviates the need for a separate polarizing device assigned to a respective first radiation device and thus, enables a simplified configuration of the apparatus.

The object is achieved by an apparatus for additively manufacturing a three-dimensional object by solidifying a build material via electromagnetic radiation at a specific wavelength, particularly by photocuring a photocurable resin which can be cured at a specific wavelength, according to claim 1. The subject-matter of the dependent claims relates to possible embodiments thereto.

A first aspect of the invention relates to an apparatus for additively manufacturing a three-dimensional object by solidifying a build material via electromagnetic radiation at a specific wavelength, particularly by photocuring a photocurable resin which can be cured at a specific wavelength with electromagnetic radiation having the specific wavelength.

The apparatus can be embodied as a selective laser sintering, SLS, apparatus configured to successively, particularly layerwise, irradiate a powdery build material, e.g. a powdery polymer material, with electromagnetic radiation, e.g. a directed light beam, at a specific wavelength which results in that respective areas of the build material melt and, upon subsequent cooling, solidify to form a cross-section of the three-dimensional object to be built. By repeating this process, a three-dimensional object can be additively built.

Alternatively, the apparatus can be embodied as a photocuring apparatus configured to successively, particularly layerwise, selectively irradiate a photocurable liquid build material, e.g. a photocurable resin, such as a photocurable polyamide resin, for instance, with electromagnetic radiation, e.g. one or more projected polarized light images and one or more directed polarized light beams, at a specific wavelength which results in that respective areas of the build material solidify via curing to form a form a cross-section of the three-dimensional object to be built. By repeating this process, a three-dimensional object can be additively built.

The latter embodiment of the apparatus is the preferred embodiment of the apparatus such that the following remarks regarding the functional and constructive configuration of the apparatus particularly relate to this embodiment; however, analogous remarks apply to embodiments in which the apparatus is embodied as a SLS-apparatus.

The apparatus is thus, preferably an apparatus for additively manufacturing a three-dimensional object by photocuring a photocurable build material, namely a photocurable resin. The apparatus is thus, preferably configured to additively manufacture a three-dimensional object by photocuring a photocurable build material, namely a photocurable resin. Curing a photocurable resin generally, comprises a successive layerwise selective irradiation of the photocurable resin with electromagnetic radiation (light) having a specific wavelength and polarization which enables photocuring of the photocurable resin to successively generate cured resin layers each corresponding to a cross-section of a three-dimensional object which is to be additively manufactured which results in an additive build-up of the three-dimensional object.

The apparatus comprises a container device. The container device can be or comprise a vat device. The container device delimits a container volume (receiving volume) for receiving the build material. The container device typically, comprises one or more container device elements. The one or more container device elements can form one or more walls of the container device which are arranged and/or oriented to delimit the container volume for receiving the build material. The container device can be supported by a base plate of the apparatus. Particularly, the container device can be supported in a receiving portion of a respective base plate of the apparatus. A respective receiving portion can be built by or comprise an opening or a recess, for instance.

The bottom of the container device or the bottom of the container volume of the container device, respectively can be built by a or comprise at least one membrane. The membrane can at least partly define a build area and a build plane, respectively of the apparatus. The membrane can be attachable or attached to one or more container device elements of the container device. The membrane is typically, transmissive to electromagnetic radiation (light) emitted from the radiation devices of the apparatus which radiation devices will be specified further below in more detail. The membrane thus, has transmissive properties at least with respect to the electromagnetic radiation emitted from the radiation devices of the apparatus. The membrane is thus, transmissive at least with respect to the optical properties, e.g. wavelength, polarization, etc. of the electromagnetic radiation emitted from the radiation devices of the apparatus.

The membrane typically, has a plane base shape. The membrane is typically, elastic and/or flexible and can thus, exhibit a reversible deflection and/or deformation behavior upon exertion of forces, such as pressure forces, during operation of the apparatus. Respective forces can directly or indirectly result from a motion of a build platform of a build platform device of the apparatus relative to the membrane. The membrane can thus, be reversibly deflected and/or deformed with respect to a zero state upon exertion of respective forces. Hence, the membrane can be built of an elastic and/or flexible material or of an elastic and/or flexible material structure enabling the respective reversible deflection and/or deformation behavior. A respective elastic and/or flexible material can be a polymer material and a respective elastic and/or flexible material structure can be a polymer material structure, for instance.

As is apparent from above, the apparatus can comprise a build platform device. The build platform device can comprise a build platform. The build platform can define a build surface on which a three-dimensional object can be additively manufactured. The build surface typically, comprises a plane area facing the container device or container volume of the container device, respectively. As will be apparent from further below, the build platform is typically moveably supported relative to the container device in at least one degree of freedom of motion.

The apparatus further comprises a support device for moveably supporting the build platform device relative to the container device in (the) at least one degree of freedom of motion. The build platform device is thus, moveably supported relative to the container device, particularly relative to the membrane, in at least one degree of freedom of motion. The at least one degree of freedom of motion is typically, a translatory freedom of motion along a translatory axis. The translatory axis is typically, arranged and oriented, respectively perpendicular relative to a base plane of the bottom of the container device or container volume of the container device, respectively. The translatory axis can therefore, be a vertical axis. The support device can comprise one or more actuator or drive devices, such as one or more electromotors, configured to effect motions of the build platform device relative to the container device along the translatory axis. The one or more actuators or drive devices can be particularly, configured to effect reciprocal motions of the build platform device along the translatory axis. The build platform device can thus, be moved in two directions, e.g. upward and downward, along the translatory axis. The build platform device can be arranged above the membrane (bottom-up configuration) or below the membrane (top-down configuration).

The apparatus comprises at least one first radiation device configured to generate one or more polarized light images corresponding to at least a part of a cross-section of a three-dimensional object to be additively manufactured with the apparatus. The one or more polarized light images generated by the at least one first radiation device have a first wavelength and a first polarization. The first wavelength particularly, corresponds to the specific wavelength of the build material at which the build material can be solidified or cured, respectively. The first wavelength can comprise a wavelength range which includes the specific wavelength of the build material at which the build material can be solidified or cured, respectively. The first wavelength is thus, chosen with respect to the solidification or curing behavior of the build material to be processed with the apparatus. The first wavelength can be in a range between 375 nm and 425 nm, particularly in a range between 385 nm and 415 nm, more particularly in a range between 395 and 405 nm, for instance.

Notably, the at least one first radiation device comprises a light source which is configured to generate and emit light with a specific polarization. Notably, the light source of the at least one first radiation device can be configured to (only) generate light having the specific polarization required for being transmitted via a selectively transmissive optical device of the apparatus (exemplary embodiments of which will be mentioned further below) towards the container device when the at least one first radiation device is arranged in pass-through mode, and the light source of the at least one radiation device can be configured to (only) generate light having the specific polarization required for being reflected via the selectively transmissive optical device of the apparatus towards the container device when the at least one first radiation device is arranged in reflection mode (both pass-through mode and reflection mode of the at least one first radiation device will be explained in more detail further below). As such, (substantially) all of the polarized light emitted from the light source of the at least one first radiation device can be used for solidification of the build material in the container device which is an important advantage over conventional apparatuses. Particularly, the at least one first radiation device can comprise a light source which is configured to generate and emit light with a specific linear polarization. More particularly, the at least one first radiation device can comprise a light source which is configured to generate and emit light with a linear polarization having a specific angular orientation. The first polarization can thus, be a linear polarization which is oriented at a first angle. The first angle can be an angle of 0° with respect to a reference axis or reference plane, respectively. The electromagnetic radiation having the first polarization can e.g. have an electric field vector oscillating in a vertical orientation. In either case, the light source of the at least one radiation device does not generate and emit light having a mixed polarization as is the case in conventional light sources of respective first radiation devices. The first polarization can thus, generally have a first angular orientation.

An important advantage of using a light source configured to generate and emit polarized light is that energy losses can be essentially decreased relative to conventional radiation devices with light sources generating and emitting unpolarized light. Conventional radiation devices with light sources generating and emitting unpolarized light regularly exhibit losses of up to 50%. Reducing respective energy losses means that the efficiency of the at least one first radiation device is essentially increased which increases the overall efficiency of a coaxial radiation unit of the apparatus which will be essentially increased. Experiments have shown that losses can be reduced at least up to 50%.

The at least one first radiation device can comprise one or more of the following operational parameters or can influence one or more of the following parameters: speed of the one or more polarized light images, energy of the one or more polarized light images, focus size of the one or more polarized light images, focus position of the one or more polarized light images, etc.

The at least one first radiation device can, in addition to the light source, comprise one or more optical functional units assigned thereto. Respective optical functional units can be or comprise at least one of: a first optical unit, e.g. comprising one or more lenses, configured to condition the polarized output of the light source and optically couple the conditioned light into a chip set, a respective chipset configured to generate a polarized light image, and a second optical unit, e.g. comprising one or more lenses, configured to condition the output of the chip set. Particularly, the first optical unit, the chip set, and the second optical unit can be arranged upstream of the light source. When the at least one first radiation device comprises a chip set, such as in an embodiment in which the at least one first radiation device is built as or comprises a digital light processing device, both the light before and after the chip set is polarized. The first radiation device including the one or more optical functional units can be constructively and/or functionally combined to form a first radiation device block.

The at least one first radiation device can generally be deemed or denoted a light image generator. In exemplary embodiments, the at least one first radiation device can be built as or comprise at least one of: a digital light processing device, a liquid crystal projector device, and a pico-projector device, for instance. As such, the light source of the at least one first radiation device can form part of at least one of: a digital light processing device, a liquid crystal projector device, and a pico-projector device. Particularly, a respective digital light processing device, DLP device, can comprise a respective chip set, i.e. particularly a DLP chip set, mentioned above. However, each of the aforementioned exemplary embodiments of the at least one first radiation device comprises a respective light source configured to generate and emit polarized light, particularly light with a linear polarization having a specific angular orientation.

The apparatus further comprises at least one second radiation device configured to simultaneously generate one or more directed polarized light beams corresponding to at least a part of a cross-section of a three-dimensional object to be additively manufactured with the apparatus. The one or more directed polarized light beams generated by the at least one second radiation device have a second wavelength and a second polarization. Also the second wavelength particularly, corresponds to the specific wavelength of the build material at which the build material can be solidified or cured, respectively. Thus, also the second wavelength comprises a wavelength range which includes the specific wavelength of the build material at which the build material can be solidified or cured, respectively. Also the second wavelength is thus, chosen with respect to the solidification behavior of the build material to be processed with the apparatus. The second wavelength can thus, be the same as the first wavelength, substantially the same as the first wavelength, or slightly deviating from the first wavelength by a value of no more than 10%, particularly no more than 5%. Accordingly, also the second wavelength can be in a range between 375 nm and 425 nm, particularly in a range between 385 nm and 415 nm, more particularly in a range between 395 and 405 nm, for instance.

The at least one second radiation device comprises a light source which is configured to generate and emit light with a specific polarization. Particularly, the at least one second radiation device can comprise a light source which is configured to generate and emit light with a specific linear polarization. More particularly, the at least one second radiation device can comprise a light source which is configured to generate and emit light with a linear polarization having a specific angular orientation. The second polarization can thus, be a linear polarization which is different from the first polarization because it is oriented at a second angle different from the first angle. The second angle can be an angle of 90° with respect to the reference axis or reference plane, respectively. The electromagnetic radiation having the second polarization can e.g. have an electric field vector oscillating in a horizontal orientation when the electric field vector of the first polarization oscillates in a vertical orientation, or vice versa. The second polarization can thus, generally have a second angular orientation which is different from, particularly perpendicular to, the first angular orientation of the first polarization.

The at least one second radiation device can comprise one or more of the following operational parameters or can influence one or more of the following parameters: speed of the one or more directed polarized light beams, energy of the one or more directed polarized light beams, focus size of the one more directed polarized light beams, focus position of the one or more directed polarized light beams, (cross-sectional) shape of the one or more directed polarized light beams, etc.

The at least one second radiation device can comprise one or more optical functional units assigned thereto. Respective optical functional units can be or comprise at least one of: a light beam source, a beam expanding unit and a beam deflection unit, e.g. a scanner unit. Particularly, the beam expanding unit can be arranged upstream of the beam deflection unit which can be arranged upstream of the light beam source. The at least one second radiation device including the one or more optical functional units can be constructively and/or functionally combined to form a second radiation device block.

The at least one second radiation device can be built as comprise a laser device, for instance. As such, the light source of the at least one second radiation device can form part of a laser device.

The at least one first radiation device and the at least one second radiation device can be simultaneously operated. Hence, the one or more polarized light images generated by the at least one first radiation device are or can be output towards the build material, while the one or more directed polarized light beams generated by the at least one second radiation device are simultaneously output towards the build material. Particularly, the one or more polarized light images generated by the at least one first radiation device which are output towards the build material can be used to solidify an inner portion, e.g. a core portion, of a respective cross-section of a respective layer of a three-dimensional object to be built. Particularly, the one or more directed polarized light beams generated by the at least one second radiation device which are simultaneously output towards the build material can be used to solidify an outer portion, e.g. a skin portion, of the respective cross-section of the respective layer of the three-dimensional object to be built. Particularly, the one or more polarized light images generated by the at least one first radiation device which are output towards the build material and the one or more directed polarized light beams generated by the at least one second radiation device which are simultaneously output towards the build material can at least partly overlap in an overlapping region, e.g. extending between a respective inner portion and a respective outer portion of the respective layer of the three-dimensional object to be built.

The at least one first radiation device and the at least one second radiation device can form part of a superordinate coaxial radiation unit of the apparatus. The coaxial radiation unit can thus, be configured to simultaneously output one or more polarized light images having a respective first wavelength and a respective first polarization and one or more directed polarized light beams having a respective second wavelength and a respective second polarization towards the container device and build material disposed therein, respectively. While the first and second wavelengths are typically, (substantially) the same, the first and second polarizations typically, differ in their angular orientation. More specifically, the first and second polarization can differ in their orientation by an angle of 90°. The coaxial radiation unit can also be deemed or denoted a hybrid lighting system which is configured to simultaneously output one or more polarized light images as well as one or more directed polarized light beams at (substantially) constant wavelength but with variable power and speed.

The coaxial radiation unit can be arranged below the container device (bottom-up configuration). However, also an inverse configuration in which the coaxial radiation unit is arranged above the container device (top-down configuration) is conceivable.

A hardware-and/or software-embodied controller can be assigned to the at least one first radiation device and the at least one second radiation device. The controller can be configured to control operation of the at least one first radiation device and the at least one second radiation device for the simultaneous generation and output of respective polarized light images and directed polarized light beams to selectively solidify the build material. Specifically, the controller can be configured to control operation of the at least one first radiation device and the at least one second radiation device with the premise that they impart the same energy density to each portion of a respective cross-section of a three-dimensional object to be built. More specifically, the controller can be configured to particularly predictively control operational parameters of the at least one first radiation device and/or the at least one second radiation device, such as e.g. speed, energy, focus, focus position, shape, etc., with the premise that the radiation devices impart the same energy density to a respective cross-section of a three-dimensional object to be built.

For the reasons set forth above, i.e. due to the fact that the at least one first radiation device comprises a light source configured to generate and emit polarized light and the advantages related thereto, an improved apparatus is provided.

The at least one light source of the at least one first radiation device can generally comprise any light source configured to emit polarized light of a specific wavelength which can be converted into polarized light images, e.g. via optical processing, as implemented by a chip set of a DLP device, for instance.

Particularly, the at least one light source of the at least one first radiation device can comprise at least one of: a monolithic light emitting diode, LED, a flat top laser, and a liquid fiber. Examples of monolithic LEDs can comprise LEDs based on InGaN or (other) nitride compositions, for instance. Examples of flat top lasers can comprise HeNe lasers, for instance. Respective lasers can comprise one or more beam shaping optics, such as e.g. diffractive or refractive elements, spatial light modulators, etc., configured to generate a flat top profile of laser beam without changing its original linear polarization. Examples of liquid fibers a can comprise a homogeneous liquid core surrounded by a cladding e.g. of polymeric material. The aforementioned concrete embodiments of a respective light source have shown both good reliability and quality with respect to the polarization of the light generated and emitted therefrom.

The apparatus can comprise at least one selectively transmissive optical device arranged in the optical path between the at least one first radiation device and/or the at least one second radiation device and the container device. The at least one selectively transmissive optical device is transmissive for the polarized light images emitted from the at least one first radiation device and reflective for the directed polarized light beams emitted from the at least one second radiation device or vice versa. The at least one selectively transmissive optical device can thus, comprise a first face opposed to the container device, the first face comprising, e.g. due to a suitable reflective coating, reflective properties for the one or more polarized light images generated by the light source of the at least one first radiation device and a second face opposing the first face, the second face comprising, e.g. due to a suitable transmissive coating, transmitting properties for the one or more directed polarized light beams generated by the light source of the at least one second radiation device, or vice versa. Hence, the selectively transmissive optical device can enable arrangements of the at least one first radiation device and the at least one second radiation device in either pass-through mode or in reflection mode (and thus, provides a high degree of flexibility with respect to the spatial arrangement of the at least one first radiation device and the at least one second radiation device.

The at least one selectively transmissive optical device is typically, configured to optically couple the one or more polarized light images generated by the at least one first radiation device and the one or more directed polarized light beams generated by the at least one second radiation device to form a resulting radiation comprising both the one or more polarized light images and the one or more directed polarized light beams which resulting radiation is directed towards and incident on the build area to selectively solidify build material in the container device. The at least one selectively transmissive optical device can thus, act as an optical coupling device. The at least one selectively transmissive optical device is typically, separate from the at least one first radiation device and the at least one second radiation device and can be provided in the region of an optical output of the at least one first radiation device and in the region of at an optical output of the at least one second radiation device.

The at least one selectively transmissive optical device can be arranged or disposed directly above or below the container device. As such, the at least one selectively transmissive optical device can directly face the container device such that there is no need to arrange or dispose any other optical device between the at least one selectively transmissive optical device and the container device which simplifies the functional and constructive configuration of the apparatus. Particularly, there is no need to arrange a conditioning, expansion and/or focusing optical group, which is adapted to condition, combined expansion and/or focusing of one or more polarized light images and one or more directed polarized light beams which are typically, polarization-coupled to each other, between the at least selectively transmissive optical device and the container device and a three-dimensional object additively built therein. Such a conditioning, expansion and/or focusing optical group can particularly, be omitted when the selectively transmissive optical device is built as or comprises at least one polarizer device having a total acceptance angle of at least 8° (as will be explained in detail in the following).

The at least one selectively transmissive optical device can thus, be built as or comprise at least one polarizer device. The at least one polarizer device can be built as or comprise at least one passive polarization filter. The passive polarization filed can be particularly configured to reflect light of a first polarization and transmit light of a second polarization, e.g. a second polarization oriented at an angle of 90° relative to the first polarization, or vice versa. The at least one polarizer device can generally comprise optical properties, e.g. implemented through a specific outer and/or inner structure, which enable that only electromagnetic radiation of a specific polarization, particularly electromagnetic radiation having a linear polarization at a specific angular orientation, can pass through, while electromagnetic radiation of a different polarization, particularly electromagnetic radiation having a linear polarization at a different angular orientation, is reflected. The at least one polarizer device can thus, be configured to reflect the one or more polarized light images generated by the at least one first radiation device towards the container device, while the one or more directed polarized light beams generated by the at least one second radiation device can pass through the polarizer device towards the container device, or vice versa. Hence, the different angular polarization of the one or more polarized light images and the one or more directed polarized light beams enables that either the one or more polarized light images can pass through the at least one polarizer device towards the build material (pass-through mode of the at least one first radiation device), while the one or more directed polarized light beams are reflected by the at least one polarizer device towards the build material (reflection mode of the at least one second radiation device), or the one or more directed polarized light beams can pass through the at least one polarizer device towards the build material (pass-through mode of the at least one second radiation device), while the one or more polarized light images are reflected by the at least one polarizer device towards the build material (reflection mode of the at least one first radiation device). Notably, the at least one polarizer device does not change the first and second wavelength. The at least one polarizer device thus, enables a coaxial simultaneous irradiation of the build material with electromagnetic radiation from the at least one first radiation device and the at least one second radiation device.

Given that the at least one polarizer device is arranged and configured to transmit the one or more polarized light images towards the container device, while it reflects the one or more directed polarized light beams towards the container device, or vice versa, the at least one polarizer device can also act as an optical coupling device since it, in either case, optically couples the one or more polarized light images and the one or more directed polarized light beams to form a resulting radiation comprising both the one or more polarized light images and the one or more directed polarized light beams which resulting radiation is incident on the build area to solidify build material.

To compensate for drawbacks related with polarizer devices typically, used in conventional apparatuses, the at least one polarizer device preferably can comprise a total acceptance angle of at least 8° (at least ±4° relative to an axis perpendicular to the build surface). Particularly, the at least one polarizer device can comprise a total acceptance angle of at least 9° (at least ±4.5° relative to an axis perpendicular to the build surface). More particularly, the at least one polarizer device can comprise a total acceptance angle of at least 10° (at least ±5° relative to an axis perpendicular to the build surface). More particularly, the at least one polarizer device can comprise a total acceptance angle of at least 11° (at least ±5.5° relative to an axis perpendicular to the build surface). More particularly, the at least one polarizer device can comprise a total acceptance angle of at least 12° (at least ±6° relative to an axis perpendicular to the build surface). More particularly, the at least one polarizer device can comprise a total acceptance angle of at least 13° (at least ±6.5° relative to an axis perpendicular to the build surface). More particularly, the at least one polarizer device can comprise a total acceptance angle of at least 14° (at least ±7° relative to an axis perpendicular to the build surface). More particularly, the at least one polarizer device can comprise a total acceptance angle of at least 15° (at least ±7.5° relative to an axis perpendicular to the build surface). More particularly, the at least one polarizer device can comprise a total acceptance angle of at least 16° (at least ±8° relative to an axis perpendicular to the build surface). More particularly, the at least one polarizer device can comprise a total acceptance angle of at least 17° (at least ±8.5° relative to an axis perpendicular to the build surface). More particularly, the at least one polarizer device can comprise a total acceptance angle of at least 18° (at least ±9° relative to an axis perpendicular to the build surface). More particularly, the at least one polarizer device can comprise a total acceptance angle of at least 19° (at least ±8.5° relative to an axis perpendicular to the build surface). More particularly, the at least one polarizer device can comprise a total acceptance angle of at least 20° (at least ±10° relative to an axis perpendicular to the build surface). More particularly, the at least one polarizer device can comprise a total acceptance angle of at least 21° (at least ±10.5° relative to an axis perpendicular to the build surface). More particularly, the at least one polarizer device can comprise a total acceptance angle of at least 22° (at least ±11° relative to an axis perpendicular to the build surface). More particularly, the at least one polarizer device can comprise a total acceptance angle of at least 23° (at least ±11.5° relative to an axis perpendicular to the build surface). More particularly, the at least one polarizer device can comprise a total acceptance angle of at least 24° (at least ±12° relative to an axis perpendicular to the build surface). More particularly, the at least one polarizer device can comprise a total acceptance angle of at least 25° (at least ±12.5° relative to an axis perpendicular to the build surface). More particularly, the at least one polarizer device can comprise a total acceptance angle of at least 26° (at least ±13° relative to an axis perpendicular to the build surface). More particularly, the at least one polarizer device can comprise a total acceptance angle of at least 27° (at least ±13.5° relative to an axis perpendicular to the build surface). More particularly, the at least one polarizer device can comprise a total acceptance angle of at least 28° (at least ±14° relative to an axis perpendicular to the build surface). More particularly, the at least one polarizer device can comprise a total acceptance angle of at least 29° (at least ±14.5° relative to an axis perpendicular to the build surface). More particularly, the at least one polarizer device can comprise a total acceptance angle of at least 30° (at least ±15° relative to an axis perpendicular to the build surface). In further embodiments, the at least one the at least one polarizer device can comprise a total acceptance angle above 30°.

The at least one polarizer device can thus, have a comparatively large total acceptance angle which enables an increased build area (in x- and y-dimensions) without changing the spatial arrangement and related constructive design of the apparatus, e.g. by changing the distance of the at least one polarizer device to the build plane and/or by changing the orientation and/or position of the at least one first radiation device and/or the at least one second radiation device relative to the container device. In other words, the optical distance, e.g. the projection distance, between the at least one first radiation device and/or the at least one second radiation device and the container device does not need to be changed, while it is still possible to obtain an increased build area relative to conventional apparatuses.

The at least one polarizer device can comprise opposing first and second faces. Respective opposing first and second faces can be provided with opposing faces of a base body (substrate) of the at least one polarizer device. Particularly, the at least one polarizer device can comprise a first face opposed to the container device, the first face comprising optically reflective properties for the one or more polarized light images generated by the at least one first radiation device and a second face opposing the first face, the second face comprising optically transmissive properties for the one or more directed polarized light beams generated by the at least one second radiation device. In such a configuration, the at least one first radiation device is typically, arranged in reflection mode and the at least one second radiation device is typically, arranged in pass-through mode. In an inverse configuration, the at least one polarizer device can comprise a first face opposed to the container device, the first face comprising optically reflective properties for the one or more directed polarized light beams generated by the at least one second radiation device and a second face opposing the first face, the second face comprising optically transmissive properties for the one or more polarized light images generated by the at least one first radiation device. In such a configuration, the at least one first radiation device is typically, arranged in pass-through mode and the at least one second radiation device is typically, arranged in reflection mode.

The at least one polarizer device can be built as or comprise a linear polarizer. Particularly, the at least one at least one polarizer device can be built as or comprise a passive linear polarization filter. As such, the at least one polarizer device can particularly, assure that light of a first polarization is or can be reflected while light of a second polarization is transmitted, or vice versa. Particularly, any linear polarizers having a respective total acceptance angle of at least 8° can be used.

A concrete exemplary embodiment of the at least one polarizer device is a wire-grid polarizer. A wire-grid polarizer can comprise a base body or substrate having at least one surface with a plurality of wire-like metallic elements in at least one grid-like arrangement. Respective metallic elements can be arranged in a plane extending at an (inclination) angle of ca. 45° relative to the build area. Respective metallic elements can be arranged in a grid-like arrangement forming at least one wire-grid layer. A respective wire-grid polarizer can comprise multiple respective wire-grid layers, e.g. arranged in a stacked arrangement. A respective wire-grid polarizer can further comprise one or more dielectric-grid layers, e.g. arranged on top of the one or more wire-grid layers. Electromagnetic waves incident of the wire-grid polarizer that have electric fields aligned parallel to the metallic elements induce the movement of electrons along the length of the metallic elements. Since the electrons are free to move in this direction, the wire-grid polarizer behaves in a similar manner to the surface of a metal when reflecting light. For electromagnetic waves incident on the wire-grid polarizer that have electric fields aligned perpendicular to the metallic elements, the electrons cannot move very far across the width of each metallic elements such that little energy is reflected and the incident electromagnetic wave is able to pass through. As such, the wire-grid polarizer is configured to cause the transmitted electromagnetic wave to be linearly polarized with an electric field completely perpendicular to the metallic elements. In other words, a wire-grid polarizer generally transmits light with a first polarization state (e.g. p polarization), e.g. oriented locally orthogonal or transverse to the metallic elements, and reflects light with a second polarization state (e.g. s polarization), e.g. oriented parallel to the metallic elements.

Additionally or alternatively to a wire-grid polarizer, a cube polarizer or a combination of a wire-grid polarizer and a cube polarizer can be used. An exemplary embodiment of a cube polarizer or a combination of a wire-grid polarizer and a cube polarizer can comprise a first prism including multiple triangular faces linked by an inner face, an outer face, and an outer side; a second prism including multiple triangular faces linked by an inner face, an outer face, and an outer side; and a polarizer arranged between the inner faces of the first and second prism. The polarizer can include an array of parallel metallic elements. Respective metallic elements can be arranged between a first substrate and a second substrate. Respective metallic elements, the first substrate, and the second substrate can be arranged between the inner faces of the first and second prism. Respective metallic elements can be arranged in a plane extending at an (inclination) angle of ca. 45° relative to the build area.

As has been indicated above, the apparatus can comprise a configuration in which the at least one first radiation device is arranged relative to the at least one selectively transmissive optical device and the at least one polarizer device, respectively such that the one or more polarized light images generated by the at least one first radiation device pass through the at least one selectively transmissive optical device and polarizer device, respectively (pass-through mode) or in which the at least one first radiation device is arranged relative to the at least one selectively transmissive optical device and the at least one polarizer device, respectively such that the one or more polarized light images generated by the at least one first radiation device are reflected by the at least one selectively transmissive optical device and polarizer device, respectively towards the container device (reflection mode). In such a manner, energy losses which are typically, higher when the at least one first radiation device is in pass-through mode can be essentially reduced due to the fact that the at least one selectively transmissive optical device and polarizer device, respectively typically, exhibits higher attenuation of the electromagnetic radiation generated by the at least one first radiation device when the electromagnetic radiation generated by the at least one first radiation device passes through the at least one selectively transmissive optical device and polarizer device, respectively. Experiments have shown that up to 18% of the energy of the polarized light images generated by a first radiation device can be lost through the at least one selectively transmissive optical device and polarizer device, respectively when the first radiation device is arranged in pass-through mode, while in reflection mode only up to 6% of the energy of the polarized light images generated by a first radiation device is lost through the at least one selectively transmissive optical device and polarizer device, respectively when the first radiation device is arranged in reflection mode. In addition to the reduction of losses due to the fact that the light source of the at least one first radiation device is configured to generates and emit polarized light, experiments have shown that an increase in efficiency of more than 90% is possible.

As indicated above, the at least one selectively transmissive optical device and the at least one polarizer device, respectively can comprise a base body (substrate) having opposing first and second faces. The base body can comprise an optical element. The optical element can be built as or comprise a polarization filter. The optical element can be made of glass, particularly silicone-glass, or any other optically transmissive material. The optical element can be, e.g. due to a suitable coating, respective metallic elements, etc., reflective for the first polarization of the one or more polarized light images of the at least one first radiation device, while is it transmissive for the second polarization of the one or more directed polarized light beams of the at least one second radiation device, or reflective for the second polarization of the one or more directed polarized light beams of the at least one second radiation device, while it is transmissive for the first polarization of the one or more polarized light images of the at least one first radiation device. The reflective properties of the optical element can be provided by a suitable reflective coating, such as a metallic coating, particularly a metallic nano-coating. A respective coating or structure is typically, provided with the face of the optical element which is used to reflect the one or more polarized light images or the one or more directed polarized light beams towards the build material. The respective other face of the optical element can be provided with a suitable anti-reflective coating, such as a metallic coating, particularly a metallic nano-coating. A respective anti-reflective coating can assure that undesired double-projections, which could reduce resolution, are avoided.

The optical element is typically, flat. The optical element can thus, have a disc-shape or a plate-shape, for instance. Particularly, at least the face of the optical element which is configured to reflect electromagnetic radiation incident thereon towards the container device and build material, respectively is flat. The flatness of the optical element or the respective face of the optical element which is configured to reflect electromagnetic radiation incident thereon towards the build material typically, means that the radius of any curvature does not exceed 5 nm. The flatness of the optical element is of particular importance for ensuring shape, position, orientation, etc. of the one or more polarized light images generated by the at least one first radiation device in reflection mode and thus, contributes to a high resolution when the at least one first radiation device is arranged in reflection mode.

As is apparent from above, the at least one selectively transmissive optical device and the at least one polarizer device, respectively can act as a mirror for the electromagnetic radiation, i.e. respective polarized light images or respective directed polarized light beams, of the respective radiation device arranged in reflection mode. As such, by changing the orientation and/or position of the at least one selectively transmissive optical device and polarizer device, respectively in at least one degree of freedom of motion, a correction of a deviation of the orientation and/or position of one or more polarized light images generated by the at least one first radiation device in the build area and/or a correction of a deviation of the orientation and/or position of one or more directed polarized light beams generated by the at least one second radiation device in the build area is possible. Likewise, a correction of, e.g. thermally induced, de-calibration effects of the at least one first radiation device and/or the at least one second radiation device is possible.

The at least one selectively transmissive optical device and the at least one polarizer device, respectively can thus, be moveably supported in at least one degree of freedom of motion. A respective degree of freedom of motion can be or comprise at least one of: a translational degree of freedom of motion along a translation axis, e.g. a horizontal and/or vertical axis, or a rotational degree of freedom of motion about a rotation axis, e.g. a horizontal and/or vertical axis. A respective rotational degree of freedom of motion about a rotation axis can also comprise a pivot motion about a pivot axis. As such, the orientation and/or position of the at least one selectively transmissive optical device and polarizer device, respectively can be changed with respect to the at least one first radiation device and/or the at least one second radiation device. Particularly, the inclination angle of the at least one selectively transmissive optical device and polarizer device, respectively relative to the at least one first radiation device and/or relative to the at least one second radiation device can be changed in at least one degree of freedom of motion, e.g. by at least one pivot motion. A change of the inclination angle of the at least one selectively transmissive optical device and polarizer device, respectively can be for the purpose of correcting imaging deviations or beam directing deviations of the at least one first radiation device or the at least one second radiation device, e.g. with respect to the orientation and/or position of one or more polarized light images generated by the at least one first radiation device in the build area and/or with respect to the orientation and/or position of the one or more directed polarized light beams generated by the at least one second radiation device in the build area. Additionally or alternatively, a change of the inclination angle of the at least one at least one selectively transmissive optical device and polarizer device, respectively can be for the purpose of correcting de-calibration effects of the at least one first radiation device and/or the at least one second radiation device.

The at least one selectively transmissive optical device and the at least one polarizer device, respectively can be attached to a support frame structure. The support frame structure can be connected to a superordinate machine frame of the apparatus. The support frame structure can comprise one or more interfaces enabling a manual or at least semi-automatic change of the orientation and/or position of the at least one selectively transmissive optical device and polarizer device, respectively relative to the at least one first radiation device and/or to the at least one second radiation device. Respective interfaces can allow for engaging with a manual transmission element, e.g. a tool, or at least one transmission element, e.g. a drive rod, which enables changing the orientation and/or position of the at least one selectively transmissive optical device and polarizer device, respectively in the described manner. Specifically, a respective transmission element can also transfer the at least one selectively transmissive optical device and/or the support frame structure from a locked state in which its orientation and/or position is locked and cannot be changed in an unlocked state in which its orientation and/or position is not locked and can be changed.

As such, one or more actuator devices can be assigned to and can be directly coupled or, e.g. via at least one respective transmission element, indirectly coupled with the at least one selectively transmissive optical device and the at least one polarizer device, respectively which are configured to generate one or more forces to move the at least one selectively transmissive optical device and polarizer device, respectively in the at least one degree of freedom of motion to change its orientation and/or position relative to the at least one first radiation device and/or the at least one second radiation device. Respective actuator devices can be built as or comprise electric drives, such as translation drives, rotation drives, etc. for instance. Respective actuator devices can be directly or indirectly coupled with the at least one selectively transmissive optical device and polarizer device, respectively to exert respective forces resulting in a desired translational and/or rotational motion of the at least one selectively transmissive optical device and polarizer device, respectively relative to the at least one first radiation device and/or the at least one second radiation device. Operation of the one or more actuator devices can be controlled by a hardware- and/or software-embodied control unit assigned thereto.

The apparatus can thus, comprise a hardware- and/or software-embodied control unit assigned to the one or more actuator devices. The control unit can be configured to control motion of the at least one selectively transmissive optical device and the at least one polarizer device, respectively in the at least one degree of freedom of motion on basis of at least one control criterion. A respective control criterion can refer to a specific imaging quality or beam directing quality of the at least one first radiation device and/or the at least one second radiation device. As such, the control unit can be configured to correct imaging deviations or beam directing deviations of the at least one first radiation device and/or the at least one second radiation device. Alternatively or additionally, the control unit can be configured to compensate for de-calibration effects of the at least one first radiation device and/or the at least one second radiation device.

The apparatus can further comprise at least one hardware- and/or software-embodied detection device configured to detect imaging deviations or beam directing deviations of the at least one first radiation device and/or the at least one second radiation device and/or de-calibration effects of the at least one first radiation device and/or the at least one second radiation device. The at least one detection device can be generally, configured to determine if a respective control criterion is met. The at least one detection device can thus, be generally configured to generate an information indicative of that a respective control criterion is met. Particularly, the at least one detection device can be configured to generate an information indicative of at least one detected imaging deviation of the at least one first radiation device and/or the at least one second radiation device and/or at least one detected de-calibration effect of the at least one first radiation device and/or the at least one second radiation device.

The at least one detection device can comprise one or more detection elements operable to detect imaging deviations or beam directing deviations of the at least one first radiation device and/or the at least one second radiation device and/or de-calibration effects of the at least one first radiation device and/or the at least one second radiation device. Respective detection elements can comprise imaging sensors or optical sensors, respectively. Respective detection elements can have a detection area oriented and/or positioned relative to the at least one first radiation device and/or the at least one second radiation device so as to detect respective imaging deviations or beam directing deviations and/or de-calibration effects. Additionally or alternatively, respective detection elements can have a detection area oriented towards the build area so as to detect respective imaging deviations or beam directing deviations and/or de-calibration effects. As an example, respective detection elements can have a detection area at least partly coinciding with the build area.

A concrete Iplary embodiment of the at least one detection device is or comprises at least one camera, for instance.

The control unit can be configured to control motions of the at least one selectively transmissive optical device and the at least one polarizer device, respectively in the at least one degree of freedom of motion on basis of a respective information provided by the at least one detection device. As such, respective detected imaging deviations or beam directing deviations and/or respective detected de-calibration effects can be used as input quantity for controlling changes of the orientation and/or position of the at least one selectively transmissive optical device and polarizer device, respectively. In such a manner, a control loop effective for reducing respective imaging deviations or beam directing deviations and/or respective de-calibration effects can be implemented. A respective control loop can particularly, be implemented before, during, or after an additive manufacturing process implemented with the apparatus. As such, also an online process-control can be implemented during an additive manufacturing process, e.g. when respective deviations and/or de-calibration effects of the at least one first radiation device and/or the at least one second radiation device are detected via the at least one detection device.

The apparatus can comprise multiple respective first radiation devices, particularly in a parallel arrangement. Providing the apparatus with multiple first radiation devices, particularly in a parallel arrangement, can also contribute to a respective increase in build area. Particularly, the increase in build area can be achieved without changes of the projection distance and without reduction of the density of energy provided in the build area and thus, without reduction in the build speed. Notably, also the increase in build area by providing multiple first radiation devices can be based on the large total acceptance angle of the at least one selectively transmissive optical device and the at least one polarizer device, respectively as set forth above since the total acceptance angle can particularly, allow for reflecting or transmitting light images generated by multiple first radiation devices.

As such, in a configuration with multiple first radiation devices, the multiple first radiation devices can be arranged relative to the at least one selectively transmissive optical device and the at least one polarizer device, respectively such that the one or more polarized light images generated by each one of the multiple first radiation devices are reflected by the at least one selectively transmissive optical device towards the build area and the build material, respectively. In an exemplary embodiment, the multiple first radiation devices can thus, be arranged in reflection mode.

In an exemplary embodiment with two respective first radiation devices, one or more polarized light images generated by the first (first) radiation device of the multiple first radiation devices can be reflected by the at least one selectively transmissive optical device and the at least one polarizer device, respectively towards a first area of the build area. The first area can completely cover or comprise the build area or can cover or comprise only a part of the build area; in the latter case, the first area is a first sub-area of the build area. A respective first sub-area can particularly be generated by irradiating polarized light images on a first sub-area of the reflective surface of the at least one selectively transmissive optical device and the at least one polarizer device, respectively such that the polarized light images are reflected towards the build material to cover the first sub-area of the build area.

Simultaneously, one or more polarized light images generated by the second (first) radiation device of the multiple first radiation devices can be reflected by the at least one selectively transmissive optical device and the at least one polarizer device, respectively towards a second area of the build area. The second area can completely cover or comprise the build area or can cover or comprise only a part of the build area; in the latter case, the second area is a second sub-area of the build area. A respective second sub-area can particularly be generated by irradiating polarized light images on a second sub-area of the reflective surface of the at least one selectively transmissive optical device and the at least one polarizer device, respectively such that the polarized light images are reflected towards the build material to cover the second sub-area of the build area.

Respective first and second sub-areas of the build area can be sized and/or shaped to cover the complete build area. The first and second sub-area can thus, have the same size and/or shape. However, it is also possible that the first and second sub-area have a different size and/or shape.

The first and second sub-area can at least partly overlap in at least one layer of the three-dimensional object to be built. This means that the build area can comprise at least one overlapping area which can be radiated with polarized light images or parts thereof from different first radiation devices. However, it is also possible that the first and second sub-areas do not overlap in at least one layer of the three-dimensional object to be built. This means that the build area does not comprise a respective overlapping area but two discrete sub-areas which can be directly adjacent to each other without a gap space, or which can be spatially separated from each other with a certain gap space. In the latter case, electromagnetic radiation from a further radiation device, e.g. a first radiation device generating a polarized light image or a second radiation device generating a directed polarized light beam, can be used to irradiate and solidify the build material in the gap space, thereby connecting the two discrete sub-areas with each other in one or more connection points or connection regions, respectively.

Analogous considerations apply in embodiments with more than two respective first radiation devices. Hence, more than two sub-areas can be provided which can overlap or which cannot overlap as described above. The build area can thus, comprise a respective overlapping area or at least two discrete sub-areas which can be directly adjacent to each other without a gap space, or which can be spatially separated from each other with at least one certain gap space. In the latter case, electromagnetic radiation from a further radiation device, e.g. a first radiation device generating a polarized light image or a second radiation device generating a directed polarized light beam, can be used to irradiate and solidify the build material in the gap space, thereby connecting the two discrete sub-areas with each other in one or more connection points or connection regions, respectively.

Additionally or alternatively, the apparatus can comprise multiple respective second radiation devices, particularly in a parallel arrangement. Providing the apparatus with multiple second radiation devices, particularly in a parallel arrangement, can also contribute to a respective increase in build area. Particularly, the increase in build area can be achieved without changes of the projection distance and without reduction of the density of energy provided in the build area and thus, without reduction in the build speed. Notably, also the increase in build area by providing multiple second radiation devices can be based on the large total acceptance angle of the at least one selectively transmissive optical device and the at least one polarizer device, respectively as set forth above, since the total acceptance angle can particularly, allow for reflecting or transmitting directed light beams generated by multiple second radiation devices.

As such, in a configuration with multiple second radiation devices, the multiple second radiation devices can be arranged relative to the at least one selectively transmissive optical device and polarizer device, respectively such that the one or more directed polarized light beams generated by each one of the multiple second radiation devices are transmitted by the at least one selectively transmissive optical device and polarizer device, respectively and pass through, respectively the at least one selectively transmissive optical device and polarizer device, respectively towards the build area and the build material, respectively. In an exemplary embodiment, the multiple second radiation devices can thus, be arranged in pass-through mode.

In an exemplary embodiment with two respective second radiation devices, one or more directed polarized light beams generated by the first (second) radiation device of the multiple second radiation devices can be transmitted by the at least one selectively transmissive optical device and polarizer device, respectively towards a first area of the build area. The first area can completely cover or comprise the build area or can cover or comprise only a part of the build area; in the latter case, the first area is a first sub-area of the build area. A respective first sub-area can particularly be generated by irradiating a directed polarized light beam on a first sub-area of the transmissive surface of the at least one selectively transmissive optical device and polarizer device, respectively such that the directed light beam is transmitted towards the build material to operate in the first sub-area of the build area.

Simultaneously, one or more directed polarized light beams generated by the second (second) radiation device of the multiple second radiation devices can be transmitted by the at least one selectively transmissive optical device and the at least one polarizer device, respectively towards a second area of the build area. The second area can completely cover or comprise the build area or can cover or comprise only a part of the build area; in the latter case, the second area is a second sub-area of the build area. A respective second sub-area can particularly be generated by irradiating one or more directed polarized light beams on a second sub-area of the transmissive surface of the at least one selectively transmissive optical device and polarizer device, respectively such that the one or more directed polarized light beams are transmitted towards the build material to operate in the second sub-area of the build area.

Respective first and second sub-areas of the build area can be sized and/or shaped to cover the complete build area. The first and second sub-area can thus, have the same size and/or shape. However, it is also possible that the first and second sub-area have a different size and/or shape. The first and second sub-area can at least partly overlap in at least one layer of the three-dimensional object to be built. This means that the build area can comprise at least one overlapping area which can be radiated with directed light beams from different second radiation devices. However, it is also possible that the first and second sub-areas do not overlap in at least one layer of the three-dimensional object to be built. This means that the build area does not comprise a respective overlapping area but two discrete sub-areas which can be directly adjacent to each other without a gap space, or which can be spatially separated from each other with a certain gap space. In the latter case, electromagnetic radiation from a further radiation device, e.g. a first radiation device generating a polarized light image or a second radiation device generating a directed polarized light beam, can be used to irradiate and solidify the build material in the gap space, thereby connecting the two discrete sub-areas with each other in one or more connection points or connection regions, respectively.

Analogous considerations apply in embodiments with more than two respective second radiation devices. Hence, more than two sub-areas can be provided which can overlap or which cannot overlap as described above. The build area can thus, comprise a respective overlapping area or at least two discrete sub-areas which can be directly adjacent to each other without a gap space, or which can be spatially separated from each other with at least one certain gap space. In the latter case, electromagnetic radiation from a further radiation device, e.g. a first radiation device generating a polarized light image or a second radiation device generating a directed polarized light beam, can be used to irradiate and solidify the build material in the gap space, thereby connecting the at least two discrete sub-areas with each other in one or more connection points or connection regions, respectively.

In embodiments with multiple second radiation devices, the polarized directed energy beams generated by the respective second radiation devices can be the same or different. In the latter case, the directed polarized light beams generated by the multiple second radiation devices can comprise at least one different beam parameter, e.g. different beam spot size (focus), different focus position, different beam intensity, different beam phase/coherency etc. However, the second wavelength of the directed polarized light beams of all second radiation devices typically, comprises a wavelength corresponding to the specific wavelength of the build material such that solidification of the build material is possible.

In embodiments with multiple first radiation devices and multiple second radiation devices, it is also possible that both at least one first radiation device as well as at least one second radiation device are arranged in a reflection mode and that at least one further first radiation device as well as at least one further second radiation device are arranged in pass-through mode.

In either embodiment, the apparatus can have a machine frame comprising one or more machine frame elements. The machine frame is configured to support one or more functional and/or constructive units of the apparatus. Respective functional and/or constructive units can particularly, comprise the at least one first radiation device and the at least one second radiation device. The machine frame can be divided in multiple compartments, wherein the container device can be arranged in a first compartment and the at least one first radiation device and the at least one second radiation device can be arranged in a second compartment. The machine frame can comprise at least one access element which can be moveably supported between an open state in which access to a three-dimensional object manufactured with the apparatus is possible and a closed state in which no access to a three-dimensional object manufactured with the apparatus is possible.

Any of the above remarks in connection with the additive manufacturing apparatus of the first aspect of the invention also generally apply the following exemplary configurations of additive manufacturing apparatuses in accordance with a second and a third aspect of the invention:

According to a second aspect of the invention, an additive manufacturing apparatus for additively manufacturing a three-dimensional object by solidifying a build material by electromagnetic radiation at a specific wavelength, particularly by photocuring a photocurable resin which can be cured at a specific wavelength range, is provided which comprises:
at least one first radiation device configured to generate one or more polarized light images having a first wavelength and a first polarization, each of the one or more polarized light images corresponding to at least a part of a cross-section of a three-dimensional object to be additively manufactured with the apparatus, the first wavelength corresponding to the specific wavelength of the build material, wherein the at least one first radiation device comprises at least one light source configured to generate and emit light of the first wavelength and the first polarization,
at least one other first radiation device configured to simultaneously generate one or more polarized light images having a second wavelength and a second polarization different from the first polarization, the second wavelength corresponding to the specific wavelength of the build material, each of the one or more polarized light images corresponding to at least a part of a cross-section of a three-dimensional object to be additively manufactured with the apparatus, wherein the at least one other first radiation device comprises at least one light source configured to generate and emit light of the second wavelength and the second polarization.

Hence, the apparatus according to the second aspect comprises in a base configuration only first radiation devices configured to generate one or more polarized light images having a first or a second wavelength, which can be identical to the first wavelength, and a first and a second polarization different from the first polarization. The apparatus can thus, have a multiple image generator configuration without any radiation device configured to generate directed light beams. Notably, at least one first radiation device can be arranged in pass-through mode and at least one other first radiation device can be arranged in reflection mode.

According to a third aspect of the invention, an additive manufacturing apparatus for additively manufacturing a three-dimensional object by solidifying a build material by electromagnetic radiation at a specific wavelength, particularly by photocuring a photocurable resin which can be cured at a specific wavelength range, is provided which comprises:
a container device, the container device delimiting a receiving volume for receiving a build material which can be solidified by electromagnetic radiation at a specific wavelength, particularly photocurable resin which can be cured at a specific wavelength range,
at least one second radiation device configured to generate one or more directed polarized beams having a first wavelength and a first polarization, each of the one or more directed polarized light beams corresponding to at least a part of a cross-section of a three-dimensional object to be additively manufactured with the apparatus, the first wavelength corresponding to the specific wavelength of the build material, wherein the at least one second radiation device comprises at least one light source configured to generate and emit light of the first wavelength and the first polarization,
at least one other second radiation device configured to simultaneously generate one or more directed polarized light beams having a second wavelength and a second polarization different from the first polarization, the second wavelength corresponding to the specific wavelength of the build material, each of the one or more directed polarized light beams corresponding to at least a part of a cross-section of a three-dimensional object to be additively manufactured with the apparatus, wherein the at least one other second radiation device comprises at least one light source configured to generate and emit light of the second wavelength and the second polarization.

Hence, the apparatus according to the third aspect comprises in a base configuration only second radiation devices configured to generate one or more directed polarized light beams having a first or a second wavelength, which can be identical to the first wavelength, and a first and a second polarization different from the first polarization. The apparatus can thus, have a multiple laser configuration without a radiation device configured to generate light images. Notably, at least one second radiation device can be arranged in pass-through mode and at least one other second radiation device can be arranged in reflection mode.

A fourth aspect of the invention relates to a method for additively manufacturing a three-dimensional object by solidifying a build material via electromagnetic radiation at a specific wavelength, particularly by photocuring a photocurable resin which can be cured at a specific wavelength. The method can be implemented by an apparatus according to the first, second, or third aspect of the invention. As such, all annotations regarding the apparatus of the first, second, or third aspect of the invention apply to the method of the fourth aspect of the invention and vice versa.

When implemented by an apparatus according to the first aspect of the invention, the method, particularly comprises the steps of: generating, via at least one first radiation device configured to generate one or more polarized light images having a first wavelength and a first polarization, each of the one or more polarized light images corresponding to at least a part of a cross-section of a three-dimensional object to be additively manufactured with the apparatus, the first wavelength particularly corresponding to the specific wavelength of the build material, wherein the at least one first radiation device comprises at least one light source of the at least one first radiation device configured to generate and emit light of the first wavelength and the first polarization, one or more polarized light images and using same to solidify build material in a respective container device to form a three-dimensional object. The method further comprises simultaneously generating, via at least one second radiation device configured to simultaneously generate one or more directed polarized light beams corresponding to at least a part of a cross-section of a three-dimensional object to be additively manufactured with the apparatus, the one or more directed polarized light beams having a second wavelength and a second polarization different from the first polarization, the second wavelength particularly corresponding to the specific wavelength of the build material, wherein the at least one second radiation device comprises at least one light source configured to generate and emit light of the second wavelength and the second polarization, one or more directed polarized light beams and using same to solidify build material in a respective container device to form a three-dimensional object.

When implemented with an apparatus according to the second aspect of the invention, the method, particularly comprises the steps of: generating, via at least one first radiation device, polarized light images having a first wavelength and a first polarization, each of the one or more polarized light images corresponding to at least a part of a cross-section of a three-dimensional object to be additively manufactured with the apparatus, the first wavelength particularly corresponding to the specific wavelength of the build material. The method further comprises simultaneously generating, via at least one other first radiation device one or more polarized light images corresponding to at least a part of a cross-section of a three-dimensional object to be additively manufactured with the apparatus, the polarized light images having a second wavelength and a second polarization different from the first polarization, the second wavelength particularly corresponding to the specific wavelength of the build material. The method comprises simultaneously irradiating the build material with the polarized light images generated by the first radiation devices. Notably, one first radiation device can be arranged in pass-through mode and another first radiation device can be arranged in reflection mode.

When implemented with an apparatus according to the third aspect of the invention, the method, particularly comprises the steps of: generating, via at least one second radiation device, directed polarized light beams having a first wavelength and a first polarization, each of the one or more directed polarized light beams corresponding to at least a part of a cross-section of a three-dimensional object to be additively manufactured with the apparatus, the first wavelength particularly corresponding to the specific wavelength of the build material. The method further comprises simultaneously generating, via at least one other second radiation device one or more directed polarized light beams corresponding to at least a part of a cross-section of a three-dimensional object to be additively manufactured with the apparatus, the directed polarized light beams having a second wavelength and a second polarization different from the first polarization, the second wavelength particularly corresponding to the specific wavelength of the build material. The method comprises simultaneously irradiating the build material with the directed polarized light beams generated by the second radiation devices. Notably, one second radiation device can be arranged in pass-through mode and another second radiation device can be arranged in reflection mode.

The disclosure will also be readily understood by the following description of exemplary embodiments in conjunction with the accompanying drawings in which:

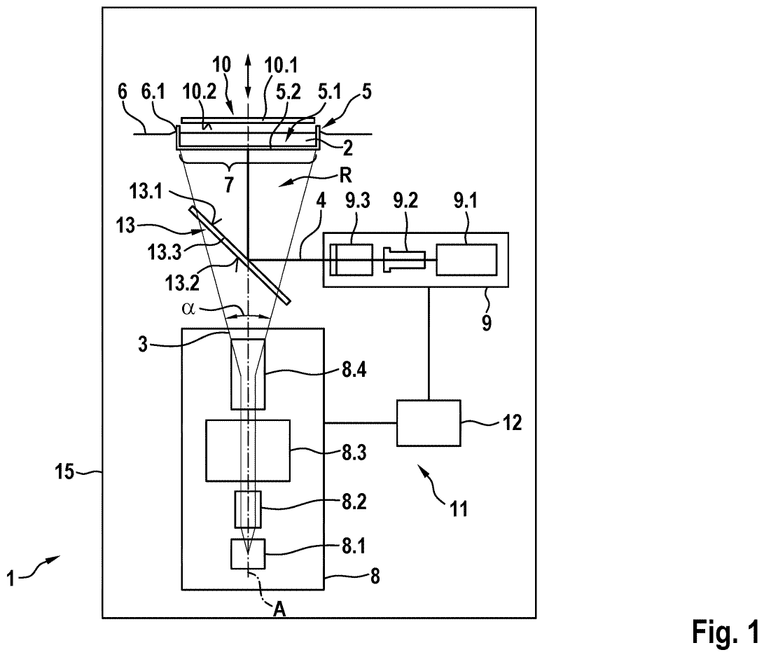

FIG. 1-6 each illustrates a principle drawing of an additive manufacturing apparatus in accordance with an exemplary embodiment.

FIG. 1 illustrates a principle drawing of an additive manufacturing apparatus 1 in accordance with a first exemplary embodiment. The apparatus 1 is generally configured for additively manufacturing a three-dimensional object (not shown) by solidifying a build material 2 via electromagnetic radiation at a specific wavelength, particularly by photocuring a photocurable resin which can be cured at a specific wavelength with electromagnetic radiation having the specific wavelength.

In the exemplary embodiments shown in FIG. 1-6, the apparatus 1 is embodied as a photocuring apparatus configured to successively, particularly layerwise, selectively irradiate a photocurable liquid build material 2, e.g. a photocurable resin, such as a photocurable polyamide resin, for instance, with electromagnetic radiation, e.g. one or more polarized light images 3 and one or more directed polarized light beams 4, at a specific wavelength which results in that respective areas of the build material 2 solidify via curing to form a cross-section of the three-dimensional object to be built. By repeating this process, a three-dimensional object can be additively built.

However, the apparatus 1 could generally also be embodied as a selective laser sintering, SLS, apparatus.

The apparatus 1 comprises a container device 5 which can be or comprise a vat device. The container device 5 delimits a container volume 5.1 (receiving volume) for receiving the build material 2. The container device 5 typically, comprises one or more container device elements which can form one or more walls of the container device 5 which are arranged and/or oriented to delimit the container volume 5.1 for receiving the build material 2. The container device 5 can be supported by a base plate 6 of the apparatus 1. Particularly, the container device 5 can be supported in a receiving portion 6.1 of the base plate 6 of the apparatus 1. The receiving portion 6.1 can be built by or comprise an opening or a recess, for instance.

The bottom of the container device 5 or the bottom of the container volume 5.1 of the container device 5, respectively is built by a or comprise a membrane 5.2. The membrane 5.2 defines a build area 7 and a build plane, respectively of the apparatus 1. The membrane 5.2 can be, particularly detachably, attachable or attached to one or more container device elements of the container device 5. The membrane 5.2 is typically, transmissive to electromagnetic radiation (light) emitted from the radiation devices 8, 9 of the apparatus 1 which radiation devices 8, 9 will be specified further below in more detail. The membrane 5.2 thus, has transmissive properties at least with respect to the electromagnetic radiation emitted from the radiation devices 8, 9 of the apparatus 1. The membrane 5.2 is thus, transmissive at least with respect to the optical properties, e.g. wavelength, polarization, etc. of the electromagnetic radiation emitted from the radiation devices 8, 9 of the apparatus 1.

The membrane 5.2 has a plane base shape. The membrane 5.2 is typically, elastic and/or flexible and can thus, exhibit a reversible deflection and/or deformation behavior upon exertion of forces, such as pressure forces, during operation of the apparatus 1. Respective forces can directly or indirectly result from a motion of a build platform 10.1 of a build platform device 10 of the apparatus 1 relative to the membrane 5.2. The membrane 5.2 can thus, be reversibly deflected and/or deformed with respect to a zero state upon exertion of respective forces. Hence, the membrane 5.2 can be built of an elastic and/or flexible material or of an elastic and/or flexible material structure enabling the respective reversible deflection and/or deformation behavior. A respective elastic and/or flexible material can be a polymer material and a respective elastic and/or flexible material structure can be a polymer material structure, for instance.

As is apparent from above, the apparatus 1 also comprises a build platform device 10. The build platform device 10 comprises the build platform 10.1 which defines a build surface 10.2 on which a three-dimensional object can be additively manufactured. The build surface 10.2 typically, comprises a plane area facing the container device 5 or container volume 5.1 of the container device 5, respectively. As will be apparent from further below, the build platform 10.1 is typically moveably supported relative to the container device 5 in at least one degree of freedom of motion.

The apparatus 1 further comprises a support device (not explicitly shown) for moveably supporting the build platform device 10 relative to the container device 5 in the at least one degree of freedom of motion. The build platform device 10 is thus, moveably supported relative to the container device 5, particularly relative to the membrane 5.2, in at least one degree of freedom of motion. The at least one degree of freedom of motion is typically, a translatory freedom of motion (as indicated by the double arrow in FIG. 1) along a translatory axis. The translatory axis is typically, arranged and oriented, respectively perpendicular relative to a base plane of the bottom of the container device 5 or container volume 5.1 of the container device 5, respectively. The translatory axis can therefore, be a vertical axis. The support device can comprise one or more actuator or drive devices (not shown), such as one or more electromotors, configured to effect motions of the build platform device 10 relative to the container device 5 along the translatory axis. The one or more actuators or drive devices can be particularly, configured to effect reciprocal motions of the build platform device 10 along the translatory axis. The build platform device 10 can thus, be moved in two directions, e.g. upward and downward, along the translatory axis. In the exemplary embodiments of the Fig., the build platform device 10 is arranged above the membrane 5.2; the apparatus 1 thus, has a bottom-up configuration. However, an arrangement of the build platform device 10 below the membrane 5.2 is also conceivable; the apparatus 1 could therefore, also have a top-down configuration.

The apparatus 1 comprises a first radiation device 8 configured to generate one or more polarized light images 3 corresponding to at least a part of a cross-section of a three-dimensional object to be additively manufactured with the apparatus 1. The one or more polarized light images 3 generated by the first radiation device 8 have a first wavelength and a first polarization. The first wavelength corresponds to the specific wavelength of the build material 2 at which the build material can be solidified or cured, respectively. The first wavelength can comprise a wavelength range which includes the specific wavelength of the build material 2 at which the build material 2 can be solidified or cured, respectively. The first wavelength is thus, chosen with respect to the solidification or curing behavior of the build material to be processed with the apparatus. The first wavelength can be in a range between 375 nm and 425 nm, particularly in a range between 385 nm and 415 nm, more particularly in a range between 395 and 405 nm, for instance.

Notably, the first radiation device 8 comprises a light source 8.1 which is configured to generate and emit light with a specific polarization. Particularly, the first radiation device 8 can comprise a light source 8.1 which is configured to generate and emit light with a specific linear polarization. More particularly, the first radiation device 8 can comprise a light source 8.1 which is configured to generate and emit light with a linear polarization having a specific angular orientation. The first polarization can thus, be a linear polarization which is oriented at a first angle. The first angle can be an angle of 0° with respect to a reference axis A or reference plane, respectively. The first polarization can thus, generally have a first angular orientation.

Since the first radiation device 8 comprises a light source 8.1 configured to generate and emit polarized light, particularly light with a linear polarization having a specific angular orientation, there is no need that the first radiation device 8 comprises a separate polarizing element. Hence, the first radiation device 8 can be provided with a simplified configuration omitting any separate means, such as respective polarizer elements, configured to generate light with a linear polarization having a specific angular orientation since already the light originally generated from and emitted by the light source 8.1 of the first radiation device 8 is polarized, particularly with a linear polarization having a specific angular orientation. An additional advantage of using a light source 8.1 configured to generate and emit polarized light is that energy losses can be essentially decreased relative to conventional radiation devices with light sources generating and emitting unpolarized light and light with mixed polarization, respectively. Conventional radiation devices with light sources generating and emitting unpolarized light and light with mixed polarization, respectively regularly exhibit losses of up to 50%. Reducing respective energy losses means that the efficiency of the first radiation device 8 is essentially increased which increases the overall efficiency of a coaxial radiation unit 11 of the apparatus 1 which will be essentially increased.

In the exemplary embodiment, the first radiation device 8 comprise one or more of the following operational parameters or can influence one or more of the following parameters: speed of the one or more polarized light images 3, energy of the one or more polarized light images 3, focus size of the one or more polarized light images 3, focus position of the one or more polarized light images 3, etc.

The first radiation device 8 can, in addition to the light source 8.1, comprise one or more optical functional units assigned thereto. Respective optical functional units can be or comprise at least one of: a first optical unit 8.2, e.g. comprising one or more lenses, configured to condition the output of the light source 8.1 and optically couple the conditioned light into a chip set 8.3, a respective chipset 8.3 configured to generate one or more polarized light images 3, and a second optical unit 8.4, e.g. comprising one or more lenses, configured to condition the output of the chip set 8.3. Particularly, the first optical coupling unit 8.2, the chip set 8.3, and the second optical unit 8.4 can be arranged upstream of the light source 8.1. The first radiation device 8 including the one or more optical functional units can be constructively and/or functionally combined to form a first radiation device block (indicated by the box surrounding the aforementioned optical functional units).

The first radiation device 8 can generally be deemed or denoted a light image generator. In exemplary embodiments, the first radiation device 8 can be built as or comprise at least one of: a digital light processing device, DLP device, a liquid crystal projector device, and a pico-projector device, for instance. Particularly, a respective digital light processing device can comprise a respective chip set 8.3 mentioned above. However, each of the aforementioned exemplary embodiments of the first radiation device 8 is configured such that their respective light source 8.1 is configured to generate and emit polarized light, particularly light with a linear polarization having a specific angular orientation.

The apparatus 1 further comprises second radiation device 9 configured to simultaneously generate one or more directed polarized light beams 4 corresponding to at least a part of a cross-section of a three-dimensional object to be additively manufactured with the apparatus 1. The one or more directed polarized light beams 4 generated by the second radiation device 9 have a second wavelength and a second polarization. Also the second wavelength corresponds to the specific wavelength of the build material 2 at which the build material can be solidified or cured, respectively. Thus, also the second wavelength comprises a wavelength range which includes the specific wavelength of the build material 2 at which the build material 2 can be solidified or cured, respectively. Also the second wavelength is thus, chosen with respect to the solidification behavior of the build material 2 to be processed with the apparatus 1. The second wavelength can thus, be the same as the first wavelength, substantially the same as the first wavelength, or slightly deviating from the first wavelength by a value of no more than 10%, particularly no more than 5%. Accordingly, also the second wavelength can be in a range between 375 nm and 425 nm, particularly in a range between 385 nm and 415 nm, more particularly in a range between 395 and 405 nm, for instance.

The second radiation device 9 comprises a light (beam) source 9.1 which is configured to generate and emit light with a specific polarization. Particularly, the second radiation device 9 can comprise a light source 9.1 which is configured to generate and emit light with a specific linear polarization. More particularly, the second radiation device 9 can comprise a light source 9.1 which is configured to generate and emit light with a linear polarization having a specific angular orientation. The second polarization can thus, be a linear polarization which is different from the first polarization because it is oriented at a second angle different from the first angle. The second angle can be an angle of 90° with respect to the reference axis or reference plane, respectively. The second polarization can thus, generally have a second angular orientation which is different from, particularly perpendicular to, the first angular orientation of the first polarization.

In the exemplary embodiments, the second radiation device 9 can comprise one or more of the following operational parameters or can influence one or more of the following parameters: speed of the one or more directed polarized light beams 4, energy of the one or more directed polarized light beams 4, focus size of the one more directed polarized light beams 4, focus position of the one or more directed polarized light beams 4, (cross-sectional) shape of the one or more directed polarized light beams 4, etc.

The second radiation device 9 can comprise one or more optical functional units assigned thereto. Respective optical functional units can be or comprise at least one of: a light beam source 9.1, a beam expanding unit 9.2 and a beam deflection unit 9.3, e.g. a scanner unit. Particularly, the beam expanding unit 9.2 can be arranged upstream of the beam deflection unit 9.3 which can be arranged upstream of the light beam source 9.1. The second radiation device 9 including the one or more optical functional units can be constructively and/or functionally combined to form a second radiation device block (indicated by the box surrounding the aforementioned optical functional units).

The second radiation device 9 can be built as comprise a laser device, for instance.

The first radiation device 8 and the second radiation device 9 can be simultaneously operated. Hence, the one or more polarized light images 3 generated by first radiation device 8 are or can be output towards the build material 2, while the one or more directed polarized light beams 4 generated by the second radiation device 9 are simultaneously output towards the build material 2. Particularly, the one or more polarized light images 3 generated by the first radiation device 8 which are output towards the build material 2 can be used to solidify an inner portion, e.g. a core portion, of a respective cross-section of a respective layer of a three-dimensional object to be built. Particularly, the one or more directed polarized light beams 4 generated by the second radiation device 9 which are simultaneously output towards the build material 2 can be used to solidify an outer portion, e.g. a skin portion, of the respective cross-section of the respective layer of the three-dimensional object to be built. Particularly, the one or more polarized light images 3 generated by the first radiation device 8 which are output towards the build material 2 and the one or more directed polarized light beams 4 generated by the second radiation device 9 which are simultaneously output towards the build material 2 can at least partly overlap in an overlapping region, e.g. extending between a respective inner portion and a respective outer portion of the respective layer of the three-dimensional object to be built.

The first radiation device 8 and the second radiation device 9 can form part of a superordinate coaxial radiation unit 11 of the apparatus 1. The coaxial radiation unit 11 can thus, be configured to simultaneously output one or more polarized light images 3 having a respective first wavelength and a respective first polarization and one or more directed polarized light beams 4 having a respective second wavelength and a respective second polarization towards the container device 5 and build material 2 disposed therein, respectively. While the first and second wavelengths are typically, (substantially) the same, the first and second polarizations typically, differ in their angular orientation. More specifically, the first and second polarization can differ in their orientation by an angle of 90°. The coaxial radiation unit 11 can also be deemed or denoted a hybrid lighting system which is configured to simultaneously output one or more polarized light images 3 as well as one or more directed polarized light beams 4 at (substantially) constant wavelength but with variable power and speed.

FIG. 1 shows that the coaxial radiation unit 11 can be arranged below the container device 5 (bottom-up configuration). However, also an inverse configuration in which the coaxial radiation unit 11 is arranged above the container device 5 (top-down configuration) is conceivable.

A hardware- and/or software-embodied controller 12 can be assigned to the first radiation device 8 and the second radiation device 9. The controller 12 can be configured to control operation of the first radiation device 8 and the second radiation device 9 for the simultaneous generation and output of respective light images 3 and directed light beams 4 to solidify the build material 2. Specifically, the controller 12 can be configured to control operation of the first radiation device 8 and the second radiation device 9 with the premise that they impart the same energy density to each portion of a respective cross-section of a three-dimensional object to be built. More specifically, the controller 12 can be configured to particularly predictively control operational parameters of the first radiation device 8 and/or the second radiation device 9, such as e.g. speed, energy, focus, focus position, shape, etc., with the premise that the radiation devices 8, 9 impart the same energy density to a respective cross-section of a three-dimensional object to be built.

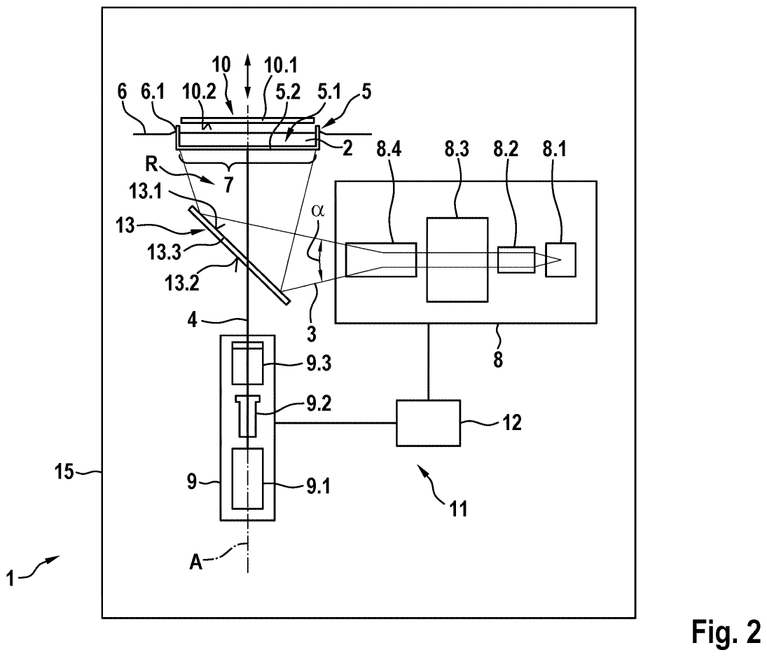

The apparatus 1 also comprises a selectively transmissive optical device 13 arranged in the optical path between the first radiation device 8 and the second radiation device 9 and the container device 5. The selectively transmissive optical device 13 can be built as or comprise a passive polarization filter configured to reflect light of a first polarization and transmit light of a second polarization, e.g. a second polarization oriented at an angle of 90° relative to the first polarization, or vice versa. In the exemplary embodiment of FIG. 1, the selectively transmissive optical device 13 is transmissive for the polarized light images 3 emitted from the light source 8.1 of the first radiation device 8 and reflective for the directed polarized light beams 4 emitted from the light source 9.1 of the second radiation device 9. Also an inverse configuration is possible as is illustrated in the exemplary embodiment of FIG. 2. The selectively transmissive optical device 13 can thus, comprise a first face 13.1 opposed to the container device 5, the first face 13.1 comprising, e.g. due to a suitable reflective coating, reflective properties for the one or more polarized light images 3 generated by the light source 8.1 of the first radiation device 8 and a second face 13.2 opposing the first face 13.1, the second face 13.2 comprising, e.g. due to a suitable transmissive coating, transmitting properties for the one or more directed polarized light beams 4 generated by the light source 9.1 of the second radiation device 9, or vice versa. Hence, the selectively transmissive optical device 13 can enable arrangements of the first radiation device 8 and the second radiation device 9 in either pass-through mode or in reflection mode and thus, provides a high degree of flexibility with respect to the spatial arrangement of the first radiation device 8 and the second radiation device 9.

The selectively transmissive optical device 13 is also configured to optically couple the one or more polarized light images 3 generated by the first radiation device 8 and the directed polarized light beams 4 generated by the second radiation device 9 to form a resulting radiation R comprising both the one or more polarized light images 3 and the one or more directed polarized light beams 4 which resulting radiation R is directed towards and incident on the build area to selectively solidify build material 2 in the container device 5. The selectively transmissive optical device 13 can thus, act as an optical coupling device. As is apparent from the Fig., the selectively transmissive optical device 13 is separate from the first radiation device 8 and the second radiation device 9 and can be provided in the region of an optical output of the first radiation device 8 and in the region of at an optical output of the second radiation device 9.

The exemplary embodiments show that the selectively transmissive optical device 13 can be arranged or disposed directly below the container device 5 in a bottom-up configuration as shown in the Fig. In a top-down configuration, the selectively transmissive optical device 13 would be arranged or disposed directly above the container device 5. As such, the selectively transmissive optical device 13 directly faces the container device 5 such that there is no need to arrange or dispose any other optical device between the selectively transmissive optical device 13 and the container device 5 which simplifies the functional and constructive configuration of the apparatus 1.

In the exemplary embodiments, the selectively transmissive optical device 13 is exemplarily built as or comprises a polarizer device such as passive polarization filter mentioned above. The polarizer device can generally comprise optical properties, e.g. implemented through a specific outer and/or inner structure, which enable that only electromagnetic radiation of a specific polarization, particularly electromagnetic radiation having a linear polarization at a specific angular orientation, can pass through, while electromagnetic radiation of a different polarization, particularly electromagnetic radiation having a linear polarization at a different angular orientation, is reflected. The polarizer device can thus, be configured to reflect the one or more directed polarized light beams 4 generated by the second radiation device 9 towards the container device 5, while the one or more polarized light images 3 generated by the first radiation device 8 can pass through the polarizer device towards the container device 5, or vice versa. Hence, the different angular polarization of the one or more polarized light images 3 and the one or more directed polarized light beams 4 enables that either the one or more polarized light images 3 can pass through the polarizer device towards the build material 2 (pass-through mode of the first radiation device 8), while the one or more directed polarized light beams 4 are reflected by the polarizer device towards the build material 2 (reflection mode of the second radiation device 9) as is shown in the exemplary embodiment of FIG. 1, or the one or more directed polarized light beams 4 can pass through the polarizer device towards the build material 2 (pass-through mode of the second radiation device 9), while the one or more polarized light images 3 are reflected by the polarizer device towards the build material 2 (reflection mode of the first radiation device 8) as is shown in the exemplary embodiment of FIG. 2. Notably, the polarizer device does not change the first and second wavelength. The polarizer device thus, in either case enables a coaxial simultaneous irradiation of the build material 2 with electromagnetic radiation from the first radiation device 8 and the second radiation device 9.

Given that the polarizer device is arranged and configured to transmit the one or more polarized light images 3 towards the container device 5, while it reflects the one or more directed polarized light beams 4 towards the container device 5, or vice versa, the polarizer device can also act as an optical coupling device since it, in either case, optically couples the one or more polarized light images 3 and the one or more directed polarized light beams 4 to form the resulting radiation R comprising both the one or more polarized light images 3 and the one or more directed polarized light beams 4 which resulting radiation R is incident on the build area to solidify build material 2.

The polarizer device preferably comprises a total acceptance angle a of at least 8° (at least ±4° relative to an axis perpendicular to the build surface such as axis A). Particularly, the polarizer device can comprise a total acceptance angle a of at least 10° (at least ±5° relative to an axis perpendicular to the build surface such as axis A). More particularly, the polarizer device can comprise a total acceptance angle a of at least 15° (at least ±7.5° relative to an axis perpendicular to the build surface such as axis A). The polarizer device can thus, have a comparatively large total acceptance angle a which enables an increased build area (in x- and y-dimensions) without changing the spatial arrangement and related constructive design of the apparatus 1, e.g. by changing the distance of the polarizer device to the build plane and/or by changing the orientation and/or position of the first radiation device 8 and/or the second radiation device 9 relative to the container device 5. In other words, the optical distance, e.g. the projection distance, between the first radiation device 8 and/or the second radiation device 9 and the container device 5 does not need to be changed, while it is still possible to obtain an increased build area relative to conventional apparatuses. The polarizer device can comprise respective opposing first and second faces 13.1, 13.2. Respective opposing first and second faces 13.1, 13.2 can be provided with opposing faces of a base body 13.3 (substrate) of the polarizer device. Particularly, the polarizer device can comprise a first face 13.1 opposed to the container device 5, the first face 13.1 can comprise optically reflective properties for the one or more polarized light images 3 generated by the first radiation device 8 and a second face 13.12 opposing the first face 13.1, the second face 13.2 comprising optically transmissive properties for the one or more directed polarized light beams 4 generated by the second radiation device 9. In such a configuration which is shown in FIG. 2, the first radiation device 8 is typically, arranged in reflection mode and the second radiation device 9 is typically, arranged in pass-through mode. In an inverse configuration which is shown in FIG. 1, the polarizer device can comprise a first face 13.1 opposed to the container device 5, the first face 13.1 comprising optically reflective properties for the one or more directed polarized light beams 4 generated by the second radiation device 9 and a second face 13.2 opposing the first face 13.1, the second face 13.2 comprising optically transmissive properties for the one or more polarized light images 3 generated by the first radiation device 8. In such a configuration, the first radiation device 8 is arranged in pass-through mode and the second radiation device 9 is arranged in reflection mode.

The polarizer device can be built as or comprise a linear polarizer. The polarizer device can thus, be configured to, when placed in an incident unpolarized light beam, produce a beam of light whose electric vector is (substantially) oscillating only in one direction.

Particularly, the polarizer device can be a wire-grid polarizer. A wire-grid polarizer can comprise a base body 13.3 or substrate having at least one surface with a plurality of wire-like metallic elements (not shown) in at least one grid-like arrangement. Respective metallic elements can be arranged in a plane extending at an (inclination) angle of ca. 45° relative to the build area. Respective metallic elements can be arranged in a grid-like arrangement forming at least one wire-grid layer. A respective wire-grid polarizer can comprise multiple respective wire-grid layers, e.g. arranged in a stacked arrangement. A respective wire-grid polarizer can further comprise one or more dielectric-grid layers, e.g. arranged on top of the one or more wire-grid layers. In other words, a wire-grid polarizer generally transmits light with a first polarization state (e.g. p polarization), e.g. oriented locally orthogonal or transverse to the metallic elements, and reflects light with a second polarization state (e.g. s polarization), e.g. oriented parallel to the metallic elements.

Additionally or alternatively to a wire-grid polarizer, a cube polarizer or a combination of a wire-grid polarizer and a cube polarizer could be used. An exemplary embodiment of a cube polarizer or a combination of a wire-grid polarizer and a cube polarizer can comprise a first prism including multiple triangular faces linked by an inner face, an outer face, and an outer side; a second prism including multiple triangular faces linked by an inner face, an outer face, and an outer side; and a polarizer arranged between the inner faces of the first and second prism. The polarizer include an array of parallel metallic elements. Respective metallic elements can be arranged between a first substrate and a second substrate. Respective metallic elements, the first substrate, and the second substrate can be arranged between the inner faces of the first and second prism. Respective metallic elements can be arranged in a plane extending at an (inclination) angle of ca. 45° relative to the build area.

As is shown in FIG. 1, the apparatus 1 can comprise a configuration in which the first radiation device 8 is arranged relative to the polarizer device such that the one or more polarized light images 3 generated by the first radiation device 8 pass through the polarizer device towards the container device 5 (pass-through mode) or, as is shown in FIG. 2, the apparatus 1 can comprise a configuration in which the first radiation device 8 is arranged relative to the polarizer device such that the one or more polarized light images 3 generated by the first radiation device 8 are reflected by the polarizer device towards the container device 5 (reflection mode). In such a manner, energy losses which are typically, higher when the first radiation device 8 is in pass-through mode can be essentially reduced due to the fact that the polarizer device typically, exhibits higher attenuation of the electromagnetic radiation generated by the first radiation device 8 when the electromagnetic radiation generated by the first radiation device 8 passes through the polarizer device. In other words, the configuration of the apparatus 1 according to FIG. 2 exhibits less losses than the configuration of the apparatus 1 according to FIG. 1.

As indicated above, the polarizer device can comprise a base body 13.3 (substrate) having opposing first and second faces 13.1, 13.2. The base body 13.3 can comprise an optical element which can be made of glass, particularly silicone-glass, or any other optically transmissive material. The optical element can be, e.g. due to a suitable coating, respective metallic elements, etc., reflective for the first polarization of the one or more polarized light images 3 of the first radiation device 8, while is it transmissive for the second polarization of the directed polarized light beams 4 of the second radiation device 9, or reflective for the second polarization of the directed polarized light beams 4 of the second radiation device 9, while it is reflective for the first polarization of the polarized light images 3 of the first radiation device 8. The reflective properties of the optical element can be provided by a suitable reflective coating, such as a metallic coating, particularly a metallic nano-coating. A respective reflective coating is typically, provided with the face of the optical element which is used to reflect the one or more polarized light images 3 or the one or more directed polarized light beams 4 towards the build material 2. The respective other face of the optical element can be provided with a suitable anti-reflective coating, such as a metallic coating, particularly a metallic nano-coating. A respective anti-reflective coating can assure that undesired double-projections, which could reduce resolution, are avoided.

The base body 13.3 and the optical element, respectively is typically, flat. The optical element can thus, have a disc-shape or a plate-shape, for instance. Particularly, at least the face of the optical element which is configured to reflect electromagnetic radiation incident thereon towards the build material 2 is flat. The flatness of the optical element or the respective face of the optical element which is configured to reflect electromagnetic radiation incident thereon towards the build material 2 typically, means that the radius of any curvature does not exceed 5 nm. The flatness of the optical element is of particular importance for ensuring shape, position, orientation, etc. of the one or more polarized light images 3 generated by the first radiation device 8 in reflection mode and thus, contributes to a high resolution when the first radiation device 8 is arranged in reflection mode.

As is apparent from above, the polarizer device can act as a selectively reflective optical element or as a mirror for the electromagnetic radiation, i.e. respective polarized light images 3 or respective directed polarized light beams 4, of the respective radiation device 8, 9 arranged in reflection mode and/or as a selectively transmissive optical element for the electromagnetic radiation, i.e. respective polarized light images 3 or respective directed polarized light beams 4, of the respective radiation device 8, 9 arranged in pass-through mode. As such, by changing the orientation and/or position of the polarizer device in at least one degree of freedom of motion, a correction of a deviation of the orientation and/or position of one or more polarized light images 3 generated by the first radiation device 8 and/or a correction of the one or more polarized directed light images 4 generated by the second radiation device 9 in the build area is possible. Likewise, a correction of, e.g. thermally induced, de-calibration effects of the first radiation device 8 and/or the second radiation device 9 is possible.

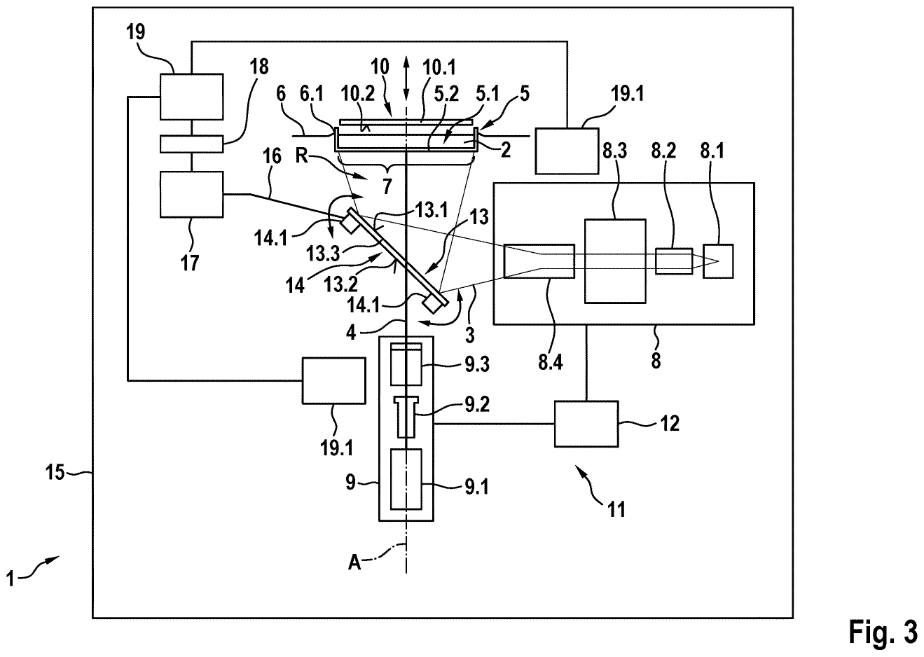

As is indicated in the exemplary embodiment of FIG. 3, the polarizer device can be moveably supported in at least one degree of freedom of motion. A respective degree of freedom of motion can be or comprise at least one of: a translational degree of freedom of motion along a translation axis, e.g. a horizontal and/or vertical axis, or a rotational degree of freedom of motion about a rotation axis, e.g. a horizontal and/or vertical axis. A respective rotational degree of freedom of motion about a rotation axis can also comprise a pivot motion about a pivot axis as is exemplarily indicated by the double-arrows in FIG. 3. As such, the orientation and/or position of the polarizer device can be changed with respect to the first radiation device 8 and/or the second radiation device 9. Particularly, the inclination angle of the polarizer device relative to the first radiation device 8 and/or relative to the second radiation device 9 can be changed in at least one degree of freedom of motion. A change of the inclination angle of the polarizer device can be for the purpose of correcting imaging deviations or beam directing deviations of the first radiation device 8 or the second radiation device 9, e.g. with respect to the orientation and/or position of one or more polarized light images 3 generated by the first radiation device 8 in the build area and/or with respect to the orientation and/or position of the one or more directed polarized light beams 4 generated by the second radiation device 9 in the build area. Additionally or alternatively, a change of the inclination angle of the polarizer device can be for the purpose of correcting de-calibration effects of the first radiation device 8 and/or the second radiation device 9.

FIG. 3 further shows that the polarizer device can be attached to a support frame structure 14. The support frame structure 14 can be connected to a superordinate machine frame 15 of the apparatus 1 as indicated in FIG. 1. The support frame structure 14 can comprise one or more interfaces 14.1 enabling a manual or at least semi-automatic change of the orientation and/or position of the polarizer device relative to the first radiation device 8 and/or to the second radiation device 9. Respective interfaces 14.1 can allow for engaging with a manual transmission element, e.g. a tool, or at least one transmission element 16, e.g. a drive rod, which enables changing the orientation and/or position of the polarizer device in the described manner. Specifically, a respective transmission element 16 can also transfer the polarizer device and/or the support frame structure 14 from a locked state in which its orientation and/or position is locked and cannot be changed in an unlocked state in which its orientation and/or position is not locked and can be changed.

As such, one or more actuator devices 17 can be assigned to and can be directly coupled or, e.g. via at least one respective transmission element 16, indirectly coupled with the polarizer device which actuator devices 17 are configured to generate one or more forces to move the polarizer device in the at least one degree of freedom of motion to change its orientation and/or position relative to the first radiation device 8 and/or the second radiation device 9. Respective actuator devices 16 can be built as or comprise electric drives, such as translation drives, rotation drives, etc. for instance. Respective actuator devices 16 can thus, be directly or indirectly coupled with the polarizer device to exert respective forces resulting in a desired translational and/or rotational motion of the polarizer device relative to the first radiation device 8 and/or the second radiation device 9. Operation of the one or more actuator devices 17 can be controlled by a hardware-and/or software-embodied control unit 18 assigned thereto.

The apparatus 1 can thus, comprise a hardware-and/or software-embodied control unit 18 assigned to the one or more actuator devices 17. The control unit 18 can be configured to control motion of the polarizer device in the at least one degree of freedom of motion on basis of at least one control criterion. A respective control criterion can refer to a specific imaging quality or beam directing quality of the first radiation device 8 and/or the second radiation device 9. As such, the control unit 18 can be configured to correct imaging deviations or beam directing deviations of the first radiation device 8 and/or the second radiation device 9. Alternatively or additionally, the control unit 18 can be configured to compensate for de-calibration effects of the first radiation device 8 and/or the second radiation device 9.

The apparatus 1 can further comprise a hardware-and/or software-embodied detection device 19 configured to detect imaging deviations or beam directing deviations of the first radiation device 8 and/or the second radiation device 9 and/or de-calibration effects of the first radiation device 8 and/or the second radiation device 9. The detection device 19 can be generally, configured to determine if a respective control criterion is met. The detection device 19 can thus, be generally configured to generate an information indicative of that a respective control criterion is met. Particularly, the detection device 19 can be configured to generate an information indicative of detected imaging deviations or beam directing deviations of the first radiation device 8 and/or the second radiation device 9 and/or detected de-calibration effects of the first radiation device 8 and/or the second radiation device 9.

The detection device 19 can comprise one or more detection elements 19.1 operable to detect imaging deviations or beam directing deviations of the first radiation device 8 and/or the second radiation device 9 and/or de-calibration effects of the first radiation device 8 and/or the second radiation device 9. Respective detection elements 19.1 can comprise imaging sensors or optical sensors, respectively. Respective detection elements 19.1 can have a detection area oriented and/or positioned relative to the first radiation device 8 and/or the second radiation device 9 so as to detect respective imaging deviations or beam directing deviations and/or de-calibration effects. Additionally or alternatively, respective detection elements 19.1 can have a detection area oriented towards the build area so as to detect respective imaging deviations or beam directing deviations and/or de-calibration effects. Additionally or alternatively, respective detection elements 19.1 can have a detection area oriented towards the build area so as to detect respective imaging deviations or beam directing deviations and/or de-calibration effects. Hence, respective detection elements 19.1 can have a detection area at least partly coinciding with the build area.

A concrete exemplary embodiment of the at least one detection device 19 is or comprises at least one camera, for instance.

The control unit 18 can be configured to control motions of the polarizer device in the at least one degree of freedom of motion on basis of a respective information provided by the detection device 19. As such, respective detected imaging deviations or beam directing deviations and/or respective detected de-calibration effects can be used as input quantity for controlling changes of the orientation and/or position of the polarizer device. In such a manner, a control loop effective for reducing respective imaging deviations or beam directing deviations and/or respective de-calibration effects can be implemented. A respective control loop can particularly, be implemented before, during, or after an additive manufacturing process implemented with the apparatus 1. As such, also an online process-control can be implemented during an additive manufacturing process, e.g. when respective deviations and/or de-calibration effects of the first radiation device 8 and/or the second radiation device 9 are detected via the detection device 19.

The exemplary configuration of the apparatus 1 shown in FIG. 3 having the first radiation device 8 in refection mode and the second radiation device 9 in pass-through mode is only exemplary and not limiting.

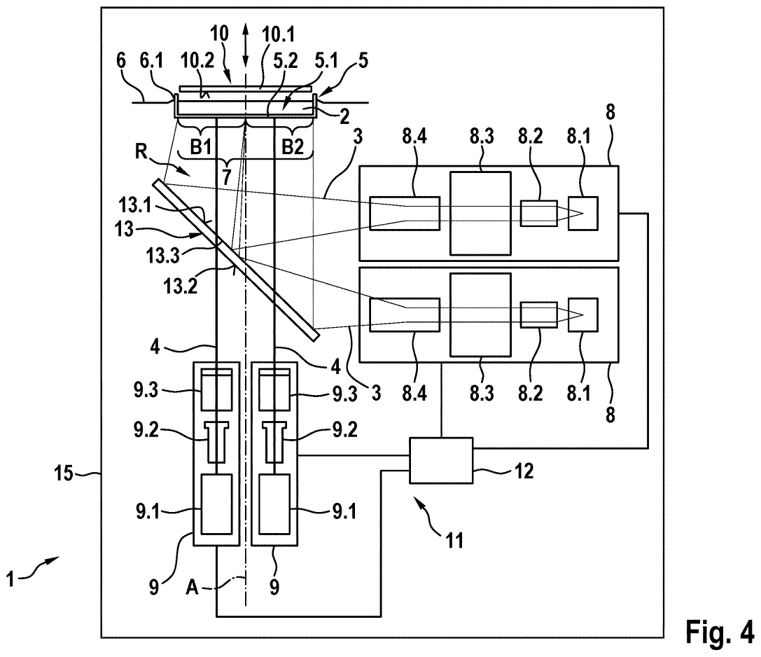

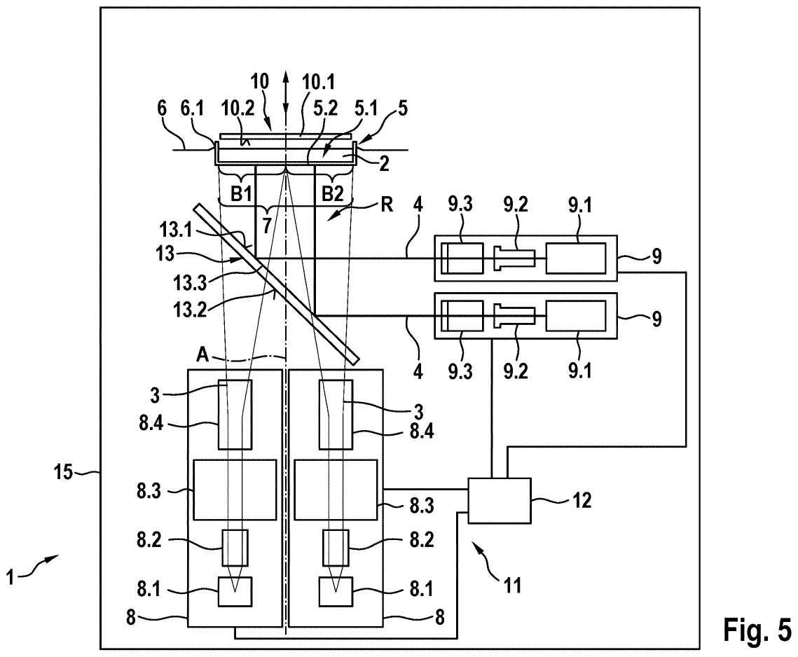

As is apparent from the exemplary embodiments of FIG. 4-6, the apparatus 1 can comprise multiple first radiation devices 8, particularly in a parallel arrangement (see particularly FIG. 4 and FIG. 5). Providing the apparatus 1 with multiple first radiation devices 8, particularly in a parallel arrangement, can also contribute to a respective increase in build area. Particularly, the increase in build area can be achieved without changes of the projection distance and without reduction of the density of energy provided in the build area and thus, without reduction in the build speed. Notably, also the increase in build area by providing multiple first radiation devices 8 is based on the large total acceptance angle of the polarizer device as set forth above since the total acceptance angle of the polarizer device can particularly, allow for reflecting or transmitting light images 3 generated by multiple first radiation devices 8.

As such, in a configuration with multiple first radiation devices 8, the multiple first radiation devices 8 can be arranged relative to the polarizer device such that the one or more polarized light images 3 generated by each one of the multiple first radiation devices 8 are reflected by the polarizer device towards the build area and the build material 2, respectively. In an exemplary embodiment, the multiple first radiation devices 8 can thus, be arranged in reflection mode as shown in FIG. 4.

In an exemplary embodiment with two first radiation devices 8 as shown in in FIG. 4, one or more polarized light images 3 generated by the first (first) radiation device 8 of the multiple first radiation devices 8 can be reflected by the polarizer device towards a first area B1 of the build area. The first area B1 can completely cover or comprise the build area or can cover or comprise only a part of the build area; in the latter case which is exemplarily shown in FIG. 4, the first area B1 is a first sub-area of the build area. A respective first sub-area can particularly be generated by irradiating polarized light images 3 on a first sub-area of the reflective surface of the polarizer device such that the polarized light images 3 are reflected towards the build material 2 to cover the first sub-area of the build area.

Simultaneously, one or more polarized light images 3 generated by the second (first) radiation device 8 of the multiple first radiation devices 8 can be reflected by the polarizer device towards a second area B2 of the build area. The second area B2 can completely cover or comprise the build area or can cover or comprise only a part of the build area; in the latter case which is exemplarily shown in FIG. 4, the second area B2 is a second sub-area of the build area. A respective second sub-area can particularly be generated by irradiating polarized light images 3 on a second sub-area of the reflective surface of the polarizer device such that the polarized light images 3 are reflected towards the build material 2 to cover the second sub-area of the build area.

Respective first and second sub-areas B1, B2 of the build area can be sized and/or shaped to cover the complete build area. The first and second sub-area B1, B2 can thus, have the same size and/or shape. However, it is also possible that the first and second sub-area B1, B2 have a different size and/or shape.

The first and second sub-area B1, B2 can at least partly overlap in at least one layer of the three-dimensional object to be built. This means that the build area can comprise at least one overlapping area which can be radiated with light images 3 or parts thereof from different first radiation devices 8. However, it is also possible that the first and second sub-areas B1, B2 do not overlap (as is exemplary shown in FIG. 4) in at least one layer of the three-dimensional object to be built. This means that the build area does not comprise a respective overlapping area but two discrete sub-areas which can be directly adjacent to each other without a gap space, or which can be spatially separated from each other with a certain gap space. In the latter case, electromagnetic radiation from a further radiation device, e.g. a second radiation device 9 generating a directed light beam 4, can be used to irradiate and solidify the build material 2 in the gap space, thereby connecting the two discrete sub-areas with each other in one or more connection points or connection regions, respectively.

Analogous considerations apply in embodiments with more than two first radiation devices 8. Hence, more than two sub-areas can be provided which can overlap or which cannot overlap as described above. The build area can thus, comprise a respective overlapping area or at least two discrete sub-areas which can be directly adjacent to each other without a gap space, or which can be spatially separated from each other with at least one certain gap space. In the latter case, electromagnetic radiation from a further radiation device, e.g. a second radiation device 9 generating a directed light beam, can be used to irradiate and solidify the build material 2 in the gap space, thereby connecting the at least two discrete sub-areas with each other in one or more connection points or connection regions, respectively.

FIG. 4 also shows that the apparatus 1 can also comprise multiple second radiation devices 9, particularly in a parallel arrangement. Providing the apparatus 1 with multiple second radiation devices 9, particularly in a parallel arrangement, can also contribute to a respective increase in build area. Particularly, the increase in build area can be achieved without changes of the projection distance and without reduction of the density of energy provided in the build area and thus, without reduction in the build speed. Notably, also the increase in build area by providing multiple second radiation devices is based on the large total acceptance angle of the polarizer device, as set forth above, since the total acceptance angle of the polarizer device can particularly, allow for reflecting or transmitting directed light beams 4 generated by multiple second radiation devices 9.

As such, in a configuration with multiple second radiation devices 9, the multiple second radiation devices 9 can be arranged relative to the polarizer device such that the one or more directed polarized light beams 4 generated by each one of the multiple second radiation devices 9 are transmitted by the polarizer device and pass through, respectively the polarizer device towards the build area and the build material 2, respectively. In an exemplary embodiment, the multiple second radiation devices 9 can thus, be arranged in pass-through mode as shown in FIG. 4.

In an exemplary embodiment with two second radiation devices 9, one or more directed polarized light beams 4 generated by the first (second) radiation device 9 of the multiple second radiation devices 9 can be transmitted by the polarizer device towards a first area B1 of the build area. The first area B1 can completely cover or comprise the build area or can cover or comprise only a part of the build area; in the latter case, the first area B1 is a first sub-area of the build area. A respective first sub-area can particularly be generated by irradiating a directed light beam 4 on a first sub-area of the transmissive surface of the polarizer device such that the directed light beam 4 is transmitted towards the build material 2 to operate in the first sub-area of the build area.

Simultaneously, one or more directed polarized light beams 4 generated by the second (second) radiation device 9 of the multiple second radiation devices 9 can be transmitted by the polarizer device towards a second area B2 of the build area. The second area B2 can completely cover or comprise the build area or can cover or comprise only a part of the build area; in the latter case, the second area B2 is a second sub-area of the build area. A respective second sub-area can particularly be generated by irradiating one or more directed polarized light beams 4 on a second sub-area of the transmissive surface of the polarizer device such that the one or more directed polarized light beams 4 are transmitted towards the build material 2 to operate in the second sub-area of the build area.

Respective first and second sub-areas of the build area can be sized and/or shaped to cover the complete build area. The first and second sub-area can thus, have the same size and/or shape. However, it is also possible that the first and second sub-area have a different size and/or shape. The first and second sub-area can at least partly overlap in at least one layer of the three-dimensional object to be built. This means that the build area can comprise at least one overlapping area which can be radiated with directed polarized light beams 4 from different second radiation devices 9. However, it is also possible that the first and second sub-areas do not overlap in at least one layer of the three-dimensional object to be built. This means that the build area does not comprise a respective overlapping area but two discrete sub-areas which can be directly adjacent to each other without a gap space, or which can be spatially separated from each other with a certain gap space. In the latter case, electromagnetic radiation from a further radiation device, e.g. a first radiation device 8 generating a polarized light image 3 or a second radiation device 9 generating a directed polarized light beam 4, can be used to irradiate and solidify the build material 2 in the gap space, thereby connecting the two discrete sub-areas with each other in one or more connection points or connection regions, respectively.

Analogous considerations apply in embodiments with more than two second radiation devices 9. Hence, more than two sub-areas can be provided which can overlap or which cannot overlap as described above. The build area can thus, comprise a respective overlapping area or at least two discrete sub-areas which can be directly adjacent to each other without a gap space, or which can be spatially separated from each other with at least one certain gap space. In the latter case, electromagnetic radiation from a further radiation device, e.g. a first radiation device 8 generating a light image 3 or a second radiation device 9 generating a directed light beam 4, can be used to irradiate and solidify the build material 2 in the gap space, thereby connecting the at least two discrete sub-areas with each other in one or more connection points or connection regions, respectively.

In embodiments with multiple second radiation devices 9, the directed energy beams 4 generated by the respective second radiation devices 9 can be the same or different. In the latter case, the directed light beams 4 generated by the multiple second radiation devices 9 can comprise at least one different beam parameter, e.g. different beam spot size (focus), different focus position, different beam intensity, different beam phase/coherency etc. However, the second wavelength of the directed light beams 4 of all second radiation devices 9 typically, comprises a wavelength corresponding to the specific wavelength of the build material 2 such that solidification of the build material 2 is possible.

FIG. 5 shows an embodiment inverse to the embodiment of FIG. 4, i.e. multiple first radiation devices 8 are arranged in pass-through mode and multiple second radiation devices 9 are arranged in reflection mode.

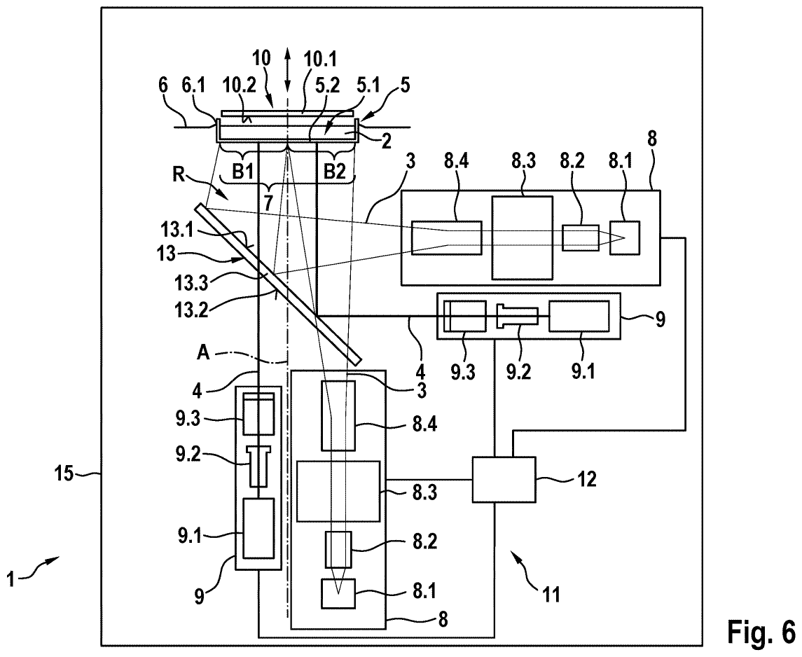

In embodiments with multiple first radiation devices 8 and multiple second radiation devices 9, it is also possible that both at least one first radiation device 8 as well as at least one second radiation device 9 are arranged in a reflection mode and that at least one further first radiation device 8 as well as at least one further second radiation device 9 are arranged in pass-through mode (see FIG. 6).

Particularly, the exemplary embodiment of FIG. 6 could also be modified such that the apparatus 1 comprises only two or more first radiation devices 8, wherein at least one first radiation device 8 is arranged in pass-through mode and at least one other first radiation device 8 is arranged in reflection mode, or such that the apparatus 1 comprises only two or more second radiation devices 9, wherein at least one second radiation device 9 is arranged in pass-through mode and at least one other second radiation device 9 is arranged in reflection mode.

As indicated above, the apparatus 1 can have a machine frame 15 comprising one or more machine frame elements, e.g. bars, rods, etc., in either embodiment. The machine frame 15 is configured to support one or more functional and/or constructive units of the apparatus 1. Respective functional and/or constructive units can particularly, comprise the at least one first radiation device 8 and the at least one second radiation device 9. The machine frame 15 can be divided in multiple compartments, wherein the container device 5 can be arranged in a first compartment and the at least one first radiation device 8 and the at least one second radiation device 9 can be arranged in a second compartment. The machine frame 15 can comprise at least one access element (not shown) which can be moveably supported between an open state in which access to a three-dimensional object manufactured with the apparatus 1 is possible and a closed state in which no access to a three-dimensional object manufactured with the apparatus 1 is possible. The base plate 6 can be directly or indirectly connected with the machine frame 15.

Each apparatus 1 is configured to implement a method for additively manufacturing a three-dimensional object by solidifying a build material via electromagnetic radiation at a specific wavelength, particularly by photocuring a photocurable resin which can be cured at a specific wavelength.

The method can comprise the steps of: generating, via at least one first radiation device 8 configured to generate one or more polarized light images 3 having a first wavelength and a first polarization, each of the one or more polarized light images 3 corresponding to at least a part of a cross-section of a three-dimensional object to be additively manufactured with the apparatus 1, the first wavelength particularly corresponding to the specific wavelength of the build material 2, wherein the at least one first radiation device 8 comprises at least one light source 8.1 configured to generate and emit light of the first wavelength and the first polarization, one or more polarized light images and using same to solidify build material in a respective container device 5 to form a three-dimensional object. The method can further comprise simultaneously generating, via at least one second radiation device 9 configured to simultaneously generate one or more directed polarized light beams 4 corresponding to at least a part of a cross-section of a three-dimensional object to be additively manufactured with the apparatus 1, the one or more directed polarized light beams 4 having a second wavelength and a second polarization different from the first polarization, the second wavelength particularly corresponding to the specific wavelength of the build material 2, wherein the at least one second radiation device 9 comprises at least one light source 9.1 configured to generate and emit light of the second wavelength and the second polarization, one or more directed polarized light beams and using same to solidify build material 2 in a respective container device 5 to form a three-dimensional object.

When implemented with an apparatus 1 comprising only first radiation devices 8, the method, particularly comprises the steps of: generating, via at least one first radiation device 8, polarized light images 3 having a first wavelength and a first polarization, each of the one or more polarized light images 3 corresponding to at least a part of a cross-section of a three-dimensional object to be additively manufactured with the apparatus 1, the first wavelength particularly corresponding to the specific wavelength of the build material. The method further comprises simultaneously generating, via at least one other first radiation device 8 one or more polarized light images 3 corresponding to at least a part of a cross-section of a three-dimensional object to be additively manufactured with the apparatus 1, the polarized light images 3 having a second wavelength and a second polarization different from the first polarization, the second wavelength particularly corresponding to the specific wavelength of the build material. The method comprises simultaneously irradiating the build material 2 with the polarized light images 3 generated by the first radiation devices 8. Notably, one first radiation device 8 can be arranged in pass-through mode and another first radiation device 8 can be arranged in reflection mode.

When implemented with an apparatus 1 comprising only second radiation devices 9 the invention, the method, particularly comprises the steps of: generating, via at least one second radiation device 9, directed polarized light beams 4 having a first wavelength and a first polarization, each of the one or more directed polarized light beams 4 corresponding to at least a part of a cross-section of a three-dimensional object to be additively manufactured with the apparatus 1, the first wavelength particularly corresponding to the specific wavelength of the build material 2. The method further comprises simultaneously generating, via at least one other second radiation device 9 one or more directed polarized light beams 4 corresponding to at least a part of a cross-section of a three-dimensional object to be additively manufactured with the apparatus 1, the directed polarized light beams 4 having a second wavelength and a second polarization different from the first polarization, the second wavelength particularly corresponding to the specific wavelength of the build material 2. The method comprises simultaneously irradiating the build material 2 with the directed polarized light beams 4 generated by the second radiation devices 9. Notably, one second radiation device 9 can be arranged in pass-through mode and another second radiation device 9 can be arranged in reflection mode.

One or more features mentioned in context with a specific embodiment of the apparatus 1 can be combined with one or more features of at least one other embodiment of the apparatus 1.

1. An additive manufacturing apparatus for additively manufacturing a three-dimensional object by solidifying a build material by electromagnetic radiation at a specific wavelength, particularly by photocuring a photocurable resin which can be cured at a specific wavelength range, the apparatus comprising:
a container device, the container device delimiting a receiving volume for receiving a build material which can be solidified by electromagnetic radiation at a specific wavelength, particularly photocurable resin which can be cured at a specific wavelength range,
at least one first radiation device configured to generate one or more polarized light images having a first wavelength and a first polarization, each of the one or more polarized light images corresponding to at least a part of a cross-section of a three-dimensional object to be additively manufactured with the apparatus, the first wavelength corresponding to the specific wavelength of the build material, wherein the at least one first radiation device comprises at least one light source configured to generate and emit light of the first wavelength and the first polarization,
at least one second radiation device configured to simultaneously generate one or more directed polarized light beams having a second wavelength and a second polarization different from the first polarization, the second wavelength corresponding to the specific wavelength of the build material, each of the one or more directed polarized light beams corresponding to at least a part of a cross-section of a three-dimensional object to be additively manufactured with the apparatus, wherein the at least one second radiation device comprises at least one light source configured to generate and emit light of the second wavelength and the second polarization; or
at least one first radiation device configured to generate one or more polarized light images having a first wavelength and a first polarization, each of the one or more polarized light images corresponding to at least a part of a cross-section of a three-dimensional object to be additively manufactured with the apparatus, the first wavelength corresponding to the specific wavelength of the build material, wherein the at least one first radiation device comprises at least one light source configured to generate and emit light of the first wavelength and the first polarization,
at least one other first radiation device configured to simultaneously generate one or more polarized light images having a second wavelength and a second polarization different from the first polarization, the second wavelength corresponding to the specific wavelength of the build material, each of the one or more polarized light images corresponding to at least a part of a cross-section of a three-dimensional object to be additively manufactured with the apparatus, wherein the at least one other first radiation device comprises at least one light source configured to generate and emit light of the second wavelength and the second polarization; or
at least one second radiation device configured to generate one or more directed polarized beams having a first wavelength and a first polarization, each of the one or more directed polarized light beams corresponding to at least a part of a cross-section of a three-dimensional object to be additively manufactured with the apparatus, the first wavelength corresponding to the specific wavelength of the build material, wherein the at least one second radiation device comprises at least one light source configured to generate and emit light of the first wavelength and the first polarization,
at least one other second radiation device configured to simultaneously generate one or more directed polarized light beams having a second wavelength and a second polarization different from the first polarization, the second wavelength corresponding to the specific wavelength of the build material, each of the one or more directed polarized light beams corresponding to at least a part of a cross-section of a three-dimensional object to be additively manufactured with the apparatus, wherein the at least one other second radiation device comprises at least one light source configured to generate and emit light of the second wavelength and the second polarization.

2-3. (canceled)

4. The apparatus of claim 1, wherein the light source of the at least one first radiation device comprises at least one of: a monolithic LED, a flat top laser, and a liquid fiber.

5. The apparatus of claim 1, wherein the at least one first radiation device comprises at least one further optical element, e.g. an optical coupling element, an optical chip set element, etc., to generate the one or more polarized light images.

6. The apparatus of claim 5, wherein the at least one first radiation device is built as or comprises a digital light processing device, a liquid crystal projector device, and a pico-projector device.

7. The apparatus of claim 1, further comprising at least one selectively transmissive optical device arranged in the optical path between the at least one first radiation device and the container device and/or the at least one second radiation device and the container device, wherein the at least one selectively transmissive optical device being transmissive for the light emitted from the first light source and reflective for the light emitted from the at least one second light source or vice versa

8. The apparatus of claim 7, wherein the at least one selectively transmissive optical device is arranged directly above or below the container device.

9. The apparatus of claim 8, wherein the at least one selectively transmissive optical device is built as or comprises a polarizer device, particularly a linear polarizer, more particularly a wire-gird polarizer.

10. The apparatus of claim 9, wherein the at least one polarizer device has a total acceptance angle of at least 4°.

11. The apparatus of claim 1, wherein the at least one first radiation device is arranged relative to the selectively transmissive optical device such that the one or more polarized light images generated and emitted by light source of the at least one first radiation device pass through the at least one selectively transmissive optical device.

12. The apparatus of claim 1, wherein the at least one first radiation device is arranged relative to the at least one selectively transmissive optical device such that the one or more polarized light images generated and emitted by the light source of the at least one first radiation device are reflected by the at least one polarizer device towards the container device.

13. The apparatus of claim 1, wherein the at least one selectively transmissive optical device comprises a flat optical element being partially reflective for the first polarization of the one or more polarized light beams generated by the light source of the at least one first radiation device or for the polarization of the one or more directed polarized light beams generated by the light source of the at least one second radiation device.

14. The apparatus according to claim 1, wherein the at least one selectively transmissive optical device is moveably supported in at least one degree of freedom of motion.

15. The apparatus of claim 14, comprising a control unit assigned to the at least one selectively transmissive optical device, the control unit configured to control motions of the at least one selectively transmissive optical device in the at least one degree of freedom of motion to correct imaging deviations or beam directing deviations of the at least one first radiation device and/or the at least one second radiation device and/or to compensate for de-calibration effects of the at least one first radiation device and/or the at least one second radiation device.

16. The apparatus of claim 1, comprising a detection device configured to detect imaging deviations or beam directing deviations of the at least one first radiation device and/or the at least one second radiation device and/or de-calibration effects of the at least one first radiation device and/or the at least one second radiation device and configured to generate an information indicative of detected imaging deviations or beam directing deviations of the at least one first radiation device and/or the at least one second radiation device and/or de-calibration effects of the at least one first radiation device and/or the at least one second radiation device.

17. The apparatus of claim 13, wherein the control unit is configured to control motions of the at least one selectively transmissive optical device in the at least one degree of freedom of motion on basis of a respective information indicative of detected imaging deviations or beam directing deviations of the at least one first radiation device and/or the at least one second radiation device and/or de-calibration effects of the at least one first radiation device and/or the at least one second radiation device.

18. The apparatus of claim 1, comprising multiple first radiation devices, particularly in a parallel arrangement, wherein the multiple first radiation devices are arranged relative to the at least one selectively transmissive optical device such that the one or more polarized light images generated by the multiple first radiation devices are reflected by the at least one selectively transmissive optical device towards the container device.

19. (canceled)

20. The apparatus of claim 1, comprising multiple second radiation devices, particularly in a parallel arrangement, wherein the multiple second radiation devices are arranged relative to the at least one selectively transmissive optical device such that the one or more directed polarized light beams generated by the multiple second radiation devices pass through the at least one selectively transmissive optical device towards the container device.

21. (canceled)

22. (canceled)

23. The apparatus of claim 1, wherein the light source of the at least one first radiation device forms part of at least one of: a digital light processing device, a liquid crystal projector device, and a pico-projector device, and/or wherein the light source of the at least one second radiation device forms part of a laser device.

24. (canceled)
